(19) United States
(12) Patent Application Publication
(10) Pub. No.: US 2017/0323061 A1
(43) Pub. Date: Nov. 9, 2017

(54) USER INTERFACES FOR MEDICAL DOCUMENTATION SYSTEM UTILIZING AUTOMATED NATURAL LANGUAGE UNDERSTANDING

(71) Applicant: Nuance Communications, Inc., Burlington, MA (US)

(72) Inventors: Howard Maurice D'Souza, Chantilly, VA (US); Debjani Sarkar, Herndon, VA (US); Regina Marie Spitznagel, Naples, FL (US); Laxmi Gottumukkala, Reston, VA (US); Diana DeMarco Brown, Acton, MA (US); Jennifer Marie Ward, Beaverton, OR (US); Sean Nicholas Stefanik, Pittsburgh, PA (US); Joanne K. Murphy, Chicago, IL (US)

(21) Appl. No.: 15/372,338

(22) Filed: Dec. 7, 2016

Related U.S. Application Data
(63) Continuation of application No. 15/366,905, filed on Dec. 1, 2016.
(60) Provisional application No. 62/332,460, filed on May 5, 2016.
(60) Provisional application No. 62/331,973, filed on May 4, 2016.
(60) Provisional application No. 62/332,460, filed on May 5, 2016.
(60) Provisional application No. 62/331,973, filed on May 4, 2016.

(51) Int. Cl. G06F 19/00; G06F 3/0482; G06F 17/27

(52) U.S. Cl. CPC G06F 19/328; G06F 19/3406; G06F 3/0482; G06F 17/2705

(57) ABSTRACT

In a system with a display and an input device, a graphical user interface (GUI) may be presented via the display. A natural language understanding engine may be applied to a free-form text documenting a clinical patient encounter, to automatically derive one or more engine-suggested medical billing codes, which may be presented in the GUI. User input may be accepted to approve at least one of the engine-suggested codes and/or to enter one or more user-added codes in the GUI, resulting in a set of user-approved codes. The set of user-approved codes may be automatically correlated to a diagnosis related group (DRG) for the patient encounter, which may be displayed. In response to user input changing the set of user-approved codes by approving or removing approval of an engine-suggested code in the GUI, the DRG may be automatically updated, and the updated DRG for the patient encounter may be displayed.

### CROSS-REFERENCE TO RELATED APPLICATIONS

This application is a continuation claiming the benefit under 35 U.S.C. §120 of U.S. patent application Ser. No. 15/366,905, filed Dec. 1, 2016, and entitled “User Interfaces for Medical Documentation System Utilizing Automated Natural Language Understanding,” which is hereby incorporated herein by reference in its entirety. This application also claims a priority benefit under 35 U.S.C. §119(e) to U.S. Provisional Patent Application No. 62/331,973, filed May 4, 2016, and entitled “User Interfaces for Medical Documentation System Utilizing Automated Natural Language Understanding,” and to U.S. Provisional Patent Application No. 62/332,460, filed May 5, 2016, and entitled “User Interfaces for Medical Documentation System Utilizing Automated Natural Language Understanding,” each of which is hereby incorporated herein by reference in its entirety.

### BACKGROUND

Medical documentation is an important process in the healthcare industry. Most healthcare institutions maintain a longitudinal medical record (e.g., spanning multiple observations or treatments over time) for each of their patients, documenting, for example, the patient's history, encounters with clinical staff within the institution, treatment received, and/or plans for future treatment. Such documentation facilitates maintaining continuity of care for the patient across multiple encounters with various clinicians over time. In addition, when an institution's medical records for large numbers of patients are considered in the aggregate, the information contained therein can be useful for educating clinicians as to treatment efficacy and best practices, for internal auditing within the institution, for quality assurance, etc.

Historically, each patient's medical record was maintained as a physical paper folder, often referred to as a “medical chart”, or “chart”. Each patient's chart would include a stack of paper reports, such as intake forms, history and immunization records, laboratory results and clinicians' notes. Following an encounter with the patient, such as an office visit, a hospital round or a surgical procedure, the clinician conducting the encounter would provide a narrative note about the encounter to be included in the patient's chart. Such a note could include, for example, a description of the reason(s) for the patient encounter, an account of any vital signs, test results and/or other clinical data collected during the encounter, one or more diagnoses determined by the clinician from the encounter, and a description of a plan for further treatment. Often, the clinician would verbally dictate the note into an audio recording device or a telephone giving access to such a recording device, to spare the clinician the time it would take to prepare the note in written form. Later, a medical transcriptionist would listen to the audio recording and transcribe it into a text document, which would be inserted on a piece of paper into the patient's chart for later reference.

Currently, many healthcare institutions are transitioning or have transitioned from paper documentation to electronic medical record systems, in which patients' longitudinal medical information is stored in a data repository in electronic form. Besides the significant physical space savings afforded by the replacement of paper record-keeping with electronic storage methods, the use of electronic medical records also provides beneficial time savings and other opportunities to clinicians and other healthcare personnel. For example, when updating a patient's electronic medical record to reflect a current patient encounter, a clinician need only document the new information obtained from the encounter, and need not spend time entering unchanged information such as the patient's age, gender, medical history, etc. Electronic medical records can also be shared, accessed and updated by multiple different personnel from local and remote locations through suitable user interfaces and network connections, eliminating the need to retrieve and deliver paper files from a crowded file room.

Another modern trend in healthcare management is the importance of medical coding for documentation and billing purposes. In the medical coding process, documented information regarding a patient encounter, such as the patient's diagnoses and clinical procedures performed, is classified according to one or more standardized sets of codes for reporting to various entities such as payment providers (e.g., health insurance companies that reimburse clinicians for their services, government healthcare payment programs, etc.). In the United States, some such standardized code systems have been adopted by the federal government, which then maintains the code sets and recommends or mandates their use for billing under programs such as Medicare.

For example, the International Classification of Diseases (ICD) numerical coding standard, developed from a European standard by the World Health Organization (WHO), was adopted in the U.S. in version ICD-9-CM (Clinically Modified). It was mandated by the Health Insurance Portability and Accountability Act of 1996 (HIPAA) for use in coding patient diagnoses. The Centers for Disease Control (CDC), the National Center for Health Statistics (NCHS), and the Centers for Medicare and Medicaid Services (CMS) are the U.S. government agencies responsible for overseeing all changes and modifications to ICD-9-CM, as well as a newer version ICD-10-CM whose adoption was announced around 2010.

Another example of a standardized code system adopted by the U.S. government is the Current Procedural Terminology (CPT) code set, which classifies clinical procedures in five-character alphanumeric codes. The CPT code set is owned by the American Medical Association (AMA), and its use was mandated by CMS as part of the Healthcare Common Procedure Coding System (HCPCS). CPT forms HCPCS Level I, and HCPCS Level II adds codes for medical supplies, durable medical goods, non-physician healthcare services, and other healthcare services not represented in CPT. CMS maintains and distributes the HCPCS Level II codes with quarterly updates. The International Classification of Diseases version ICD-10 in the U.S. also includes a clinical procedure code set ICD-10-PCS (in addition to the diagnosis code set ICD-10-CM). Since CMS's adoption of ICD-10, both diagnoses and procedures can be coded according to the updated ICD standard, using the ICD-10-CM and ICD-10-PCS code sets, respectively.

Conventionally, the coding of a patient encounter has been a manual process performed by a human professional, referred to as a “medical coder” or simply “coder,” with expert training in medical terminology and documentation as well as the standardized code sets being used and the relevant regulations. The coder would read the available documentation from the patient encounter, such as the clinicians' narrative reports, laboratory and radiology test results, etc., and determine the appropriate codes to assign to the encounter. The coder might make use of a medical coding system, such as a software program running on suitable hardware, that would display the documents from the patient encounter for the coder to read, and allow the coder to manually input the appropriate codes into a set of fields for entry in the record. Once finalized, the set of codes entered for the patient encounter could then be sent to a payment provider, which would typically determine the level of reimbursement for the encounter according to the particular codes that were entered.

### SUMMARY

One type of embodiment is directed to a system comprising at least one display, at least one input device, at least one processor, and at least one storage medium storing processor-executable instructions that, when executed by the at least one processor, perform a method comprising: applying a natural language understanding engine to a free-form text documenting a clinical patient encounter, to automatically derive one or more engine-suggested medical billing codes for the clinical patient encounter; presenting the engine-suggested medical billing codes for the clinical patient encounter in a graphical user interface (GUI) via the at least one display; accepting user input via the at least one input device to approve at least one of the engine-suggested medical billing codes and/or to enter one or more user-added medical billing codes for the clinical patient encounter in the GUI, resulting in a set of user-approved medical billing codes for the clinical patient encounter; automatically correlating the set of user-approved medical billing codes to a diagnosis related group (DRG) for the clinical patient encounter and displaying the DRG in the GUI via the at least one display; and in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.

Another type of embodiment is directed to at least one non-transitory computer-readable storage medium storing computer-executable instructions that, when executed, perform a method comprising: applying a natural language understanding engine to a free-form text documenting a clinical patient encounter, to automatically derive one or more engine-suggested medical billing codes for the clinical patient encounter; presenting the engine-suggested medical billing codes for the clinical patient encounter in a graphical user interface (GUI) via at least one display; accepting user input via at least one input device to approve at least one of the engine-suggested medical billing codes and/or to enter one or more user-added medical billing codes for the clinical patient encounter in the GUI, resulting in a set of user-approved medical billing codes for the clinical patient encounter; automatically correlating the set of user-approved medical billing codes to a diagnosis related group (DRG) for the clinical patient encounter and displaying the DRG in the GUI via the at least one display; and in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.

Another type of embodiment is directed to a method comprising: applying a natural language understanding engine, implemented via at least one processor, to a free-form text documenting a clinical patient encounter, to automatically derive one or more engine-suggested medical billing codes for the clinical patient encounter; presenting the engine-suggested medical billing codes for the clinical patient encounter in a graphical user interface (GUI) via at least one display; accepting user input via at least one input device to approve at least one of the engine-suggested medical billing codes and/or to enter one or more user-added medical billing codes for the clinical patient encounter in the GUI, resulting in a set of user-approved medical billing codes for the clinical patient encounter; automatically correlating the set of user-approved medical billing codes to a diagnosis related group (DRG) for the clinical patient encounter and displaying the DRG in the GUI via the at least one display; and in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.

Another type of embodiment is directed to a system comprising at least one display, at least one input device, at least one processor, and at least one storage medium storing processor-executable instructions that, when executed by the at least one processor, perform a method comprising: applying a natural language understanding engine to a free-form text documenting a clinical patient encounter, to automatically derive a first set of one or more engine-suggested medical billing codes for the clinical patient encounter; presenting the first set of engine-suggested medical billing codes for the clinical patient encounter in a graphical user interface (GUI) via the at least one display; accepting user input via the at least one input device to modify the presented first set of engine-suggested medical billing codes in the GUI, resulting in an unfinalized set of user-approved medical billing codes for the clinical patient encounter; adjusting the natural language understanding engine using the user modification of the first set of engine-suggested medical billing codes as feedback; applying the adjusted natural language understanding engine to automatically derive a second set of one or more engine-suggested medical billing codes for the clinical patient encounter, the second set being different from the first set; and presenting the second set of engine-suggested medical billing codes for user review in the GUI before finalizing coding of the clinical patient encounter.

Another type of embodiment is directed to at least one non-transitory computer-readable storage medium storing computer-executable instructions that, when executed, perform a method comprising: applying a natural language understanding engine to a free-form text documenting a clinical patient encounter, to automatically derive a first set of one or more engine-suggested medical billing codes for the clinical patient encounter; presenting the first set of engine-suggested medical billing codes for the clinical patient encounter in a graphical user interface (GUI) via at least one display; accepting user input via at least one input device to modify the presented first set of engine-suggested medical billing codes in the GUI, resulting in an unfinalized set of user-approved medical billing codes for the clinical patient encounter; adjusting the natural language understanding engine using the user modification of the first set of engine-suggested medical billing codes as feedback; applying the adjusted natural language understanding engine to automatically derive a second set of one or more engine-suggested medical billing codes for the clinical patient encounter, the second set being different from the first set; and presenting the second set of engine-suggested medical billing codes for user review in the GUI before finalizing coding of the clinical patient encounter.

Another type of embodiment is directed to a method comprising: applying a natural language understanding engine, implemented via at least one processor, to a free-form text documenting a clinical patient encounter, to automatically derive a first set of one or more engine-suggested medical billing codes for the clinical patient encounter; presenting the first set of engine-suggested medical billing codes for the clinical patient encounter in a graphical user interface (GUI) via at least one display; accepting user input via at least one input device to modify the presented first set of engine-suggested medical billing codes in the GUI, resulting in an unfinalized set of user-approved medical billing codes for the clinical patient encounter; adjusting the natural language understanding engine using the user modification of the first set of engine-suggested medical billing codes as feedback; applying the adjusted natural language understanding engine to automatically derive a second set of one or more engine-suggested medical billing codes for the clinical patient encounter, the second set being different from the first set; and presenting the second set of engine-suggested medical billing codes for user review in the GUI before finalizing coding of the clinical patient encounter.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary operating environment for a clinical language understanding (CLU) system that may be employed in connection with some embodiments;

FIG. 2 is a screenshot illustrating an exemplary graphical user interface for review of extracted medical facts in accordance with some embodiments;

FIGS. 3A and 3B are screenshots illustrating an exemplary display of medical facts in a user interface in accordance with some embodiments;

FIG. 4 is a screenshot illustrating an exemplary display of linkage between text and a medical fact in accordance with some embodiments;

FIG. 5 is a screenshot illustrating an exemplary interface for entering a medical fact in accordance with some embodiments;

FIG. 6 is a block diagram of an exemplary computer system on which aspects of some embodiments may be implemented;

FIGS. 7A-7F are screenshots illustrating aspects of an exemplary user interface for a computer-assisted coding (CAC) system in accordance with some embodiments;

FIG. 8 is a screenshot illustrating an exemplary code finalization screen in accordance with some embodiments;

FIGS. 9A-9I are screenshots illustrating other aspects of an exemplary user interface for a CAC system in accordance with some embodiments;

FIGS. 10A-10D are screenshots illustrating aspects of another exemplary user interface for a CAC system in accordance with some embodiments; and

FIG. 11 is a block diagram of an exemplary computer system on which aspects of some embodiments may be implemented.

### DETAILED DESCRIPTION

Some embodiments described herein may make use of a natural language understanding (NLU) engine to automatically derive medical billing codes for a clinical patient encounter from free-form text documenting the encounter. In some embodiments, the NLU engine may be implemented as part of a clinical language understanding (CLU) system; examples of possible functionality for such a CLU system are described in detail below. In some embodiments, the medical billing codes derived by the NLU engine may be suggested to a human user such as a medical coding professional (“coder”) coding the patient encounter via a computer-assisted coding (CAC) system; examples of possible functionality for such a CAC system are also described in detail below.

The inventors have appreciated that it may often be advantageous for medical coding to be an interactive process between an automated NLU system and a human coder. In some embodiments, the CAC system may provide an interface for the human coder to review codes automatically derived and suggested by the NLU engine, and to accept, reject, and/or modify them. In some embodiments, the CAC system may also allow the coder to manually enter codes not suggested by the NLU engine. Codes entered by the coder, or suggested by the NLU engine and then accepted by the coder, or suggested and then modified and accepted by the coder, may then be considered user-approved codes for the patient encounter. The inventors have appreciated that exposing the human coder to automatically-derived codes, as well as allowing the coder to supplement and correct the automatically-derived codes (which corrections may then, in some embodiments, be used to train the NLU engine to increase its accuracy), may provide the benefit in some embodiments of facilitating more accurate coding and billing as the NLU engine and the human coder each help fill performance gaps of the other. Providing the coder with codes initially suggested automatically by the NLU engine may also promote efficiency in the coding process, giving the coder a head start on the work of reviewing the clinical documentation and identifying the appropriate medical codes, in some embodiments.

The inventors have further recognized that coding efficiency may be enhanced by integrating manual coding and human review of automatically-derived codes in a single software application promoting focus, speed, and ease of use. In some embodiments, a CAC application may present a unified workspace in which both automatically-derived and manually-added codes may be presented for the coder to review and define a finalized set of codes for the patient encounter. In some embodiments, the NLU engine-suggested billing codes and the user-added billing codes may be presented together in the same window in a graphical user interface (GUI). In some cases, the current set of codes in the workspace for a patient encounter being worked on in the CAC system may also include one or more billing codes derived from another source, e.g., added external to the CAC GUI. In some embodiments, providing an integrated workspace for review of billing codes from all or various sources may allow for enhanced coding and documenting functionality, such as providing automated coding alerts based on the full set of codes for the patient encounter, allowing the NLU engine to adapt and learn from feedback including not just user actions on engine-suggested codes but also user-added codes and actions, etc.

In some embodiments, a unified CAC coding workspace as developed and disclosed herein may allow for the coder to be provided with immediate encounter-level information based on actions directed to individual engine-suggested codes, allowing the coder to see how the individual actions affect the encounter-level information. For example, in some embodiments, the CAC workspace may provide an indication of the diagnosis related group (DRG) automatically determined from the current set and sequence of codes for the patient encounter. The DRGs are a standardized set of groups into which hospital patient encounters are classified in the U.S. for purposes of Medicare reimbursement. Based on the medical billing codes (e.g., ICD diagnosis codes, procedure codes, etc.) assigned to the patient encounter, and in some cases also based on demographic data of the patient (age, sex, etc.), each patient encounter is correlated to one of several hundred groups in the DRG system, and the hospital is paid the same fixed rate for all patient encounters in the same DRG. In some embodiments disclosed herein, when a user takes an action on an engine-suggested code in the unified coding workspace (e.g., approving the engine-suggested code, removing approval, rejecting the code, modifying the code, etc.), the application may automatically update the DRG to which the current set of user-approved codes for the patient encounter correlates, and may display the updated DRG in the workspace for the user to appreciate the effect that the action may have on this encounter-level data field (and consequently to the reimbursement level for the patient encounter). The inventors have appreciated that providing such feedback to the user during a unified process of manual coding and reviewing engine-suggested codes may enhance accuracy and efficiency of the coding process in some embodiments by making the effects of individual actions on engine-suggested codes immediately recognizable.

Likewise, in some embodiments with a unified CAC coding application, training/adaptation feedback may be provided to the NLU engine in a frequent and/or timely manner, e.g., while the coding process is ongoing and before the set of codes for billing the patient encounter is finalized. In this way, in some embodiments, relevant adaptations to the NLU engine based on feedback from coding the current encounter may be applied to improve the engine-suggested codes in the same encounter, such that the coder may then review the improved suggestions before finalizing the same encounter. The inventors have recognized that such timely feedback and adaptation may enhance the coding accuracy of individual patient encounters over systems utilizing separate CAC and manual coding applications, in which it may be necessary to wait for retraining/adaptation of the NLU engine to be performed offline using feedback from a finalized encounter whose coding was completed in a separate application.

In some embodiments disclosed herein, efficiency may also be promoted by filtering the automatically-derived codes that are presented to the coder via the CAC interface. For example, in some embodiments, when the human user has already approved one or more medical billing codes for a patient encounter and one or more new codes are derived by the NLU engine, the new engine-derived codes may be compared with the user-approved codes. In some embodiments, when an engine-derived code is identified as overlapping with a user-approved code, the user-approved code may be retained instead of the engine-derived code. In some embodiments, this may involve presenting the user-approved code in the user interface of a medical coding system (e.g., a CAC system) while suppressing presentation of the engine-derived code.

An engine-derived code may be identified as overlapping with a user-approved code in any of various possible ways. In one example, two diagnosis codes that are the same code may be identified as overlapping. In another example, two procedure codes that are the same code may be identified as overlapping, if it can be determined that the patient did not actually undergo the same procedure twice. In yet another example, two codes may be identified as overlapping when one code is a less specific version of the other code. In some embodiments, when an engine-derived code is a less specific version of a user-approved code, the more specific user-approved code may be retained instead of the less-specific engine-derived code.

In some embodiments, when a medical billing code is derived from documenting text by the NLU engine, the engine may also provide a link between the derived code and one or more corresponding portions of the text, from which the code was derived. In some embodiments, when the engine-derived code is identified as overlapping with a user-approved code, the text portion linked to the engine-derived code may then be linked to the user-approved code. In some embodiments, this may result in presentation of the linked text in the user interface of the CAC system in association with the user-approved code, despite the engine-derived code not being presented in the user interface.

In some embodiments, the source of each medical billing code being considered for the current patient encounter may be tracked for any of various purposes, such as facilitating user review of the codes, and/or training the NLU engine. For example, in some embodiments, each code being considered may be associated with identifying data indicating whether the code was engine-suggested, engine-suggested and user-approved, engine-suggested and user-rejected, engine-suggested and user-modified, user-added within the CAC interface, or added from another source, etc. In some embodiments, this data for each code may be provided to the user in the CAC GUI, e.g., via any suitable visual identifier, to facilitate the user's understanding and review of the current set of codes for the encounter. In some embodiments, the identifying data for the codes may be used to determine whether and how each code should be used for adaptation of the NLU engine for use in automatically deriving billing codes for future patient encounters and/or for improving the engine-suggested codes for the current patient encounter. For example, in some embodiments, codes on which the user took action in the CAC workspace (e.g., by taking action on an engine-suggested code, or by manually adding a code, etc.) may be fed back to the NLU engine for learning. In some embodiments, codes added external to the CAC GUI may be assumed to be less related to the text documentation on which the NLU engine operated, and may not be used for engine training.

While a number of inventive features for clinical documentation processes are described above, it should be appreciated that embodiments of the present invention may include any one of these features, any combination of two or more features, or all of the features, as aspects of the invention are not limited to any particular number or combination of the above-described features. The aspects of the present invention described herein can be implemented in any of numerous ways, and are not limited to any particular implementation techniques. Described below are examples of specific implementation techniques; however, it should be appreciate that these examples are provided merely for purposes of illustration, and that other implementations are possible.

Clinical Language Understanding (CLU) System

As discussed above, many modern healthcare institutions are transitioning or have transitioned from paper documentation to electronic medical record systems and electronic billing processes, and the inventors have recognized a desire in the healthcare profession for improved tools for making these systems and processes more efficient, accurate, and comfortable. An Electronic Health Record (EHR), or electronic medical record (EMR), is a digitally stored collection of health information that generally is maintained by a specific healthcare institution and contains data documenting the care that a specific patient has received from that institution over time. Typically, an EHR is maintained as a structured data representation, such as a database with structured fields. Each piece of information stored in such an EHR is typically represented as a discrete (e.g., separate) data item occupying a field of the EHR database. For example, a 55-year old male patient named John Doe may have an EHR database record with “John Doe” stored in the patient_name field, “55” stored in the patient_age field, and “Male” stored in the patient_gender field. Data items or fields in such an EHR are structured in the sense that only a certain limited set of valid inputs is allowed for each field. For example, the patient_name field may require an alphabetic string as input, and may have a maximum length limit; the patient_age field may require a string of three numerals, and the leading numeral may have to be “0” or “1”; the patient_gender field may only allow one of two inputs, “Male” and “Female”; a patient birth date field may require input in a “MM/DD/YYYY” format; etc.

Typical EHRs are also structured in terms of the vocabulary they use, as medical terms are normalized to a standard set of terms utilized by the institution maintaining the EHR. The standard set of terms may be specific to the institution, or may be a more widely used standard. For example, a clinician dictating or writing a free-form note may use any of a number of different terms for the condition of a patient currently suffering from an interruption of blood supply to the heart, including “heart attack”, “acute myocardial infarction”, “acute MI” and “AMI”. To facilitate interoperability of EHR data between various departments and users in the institution, and/or to allow identical conditions to be identified as such across patient records for data analysis, a typical EHR may use only one standardized term to represent each individual medical concept. For example, “acute myocardial infarction” may be the standard term stored in the EHR for every case of a heart attack occurring at the time of a clinical encounter. Some EHRs may represent medical terms in a data format corresponding to a coding standard, such as the International Classification of Disease (ICD) standard. For example, “acute myocardial infarction” may be represented in an EHR as “ICD-9 410”, where 410 is the code number for “acute myocardial infarction” according to the ninth edition of the ICD standard.

To allow clinicians and other healthcare personnel to enter medical documentation data directly into an EHR in its discrete structured data format, many EHRs are accessed through user interfaces that make extensive use of point-and-click input methods. While some data items, such as the patient's name, may require input in (structured) textual or numeric form, many data items can be input simply through the use of a mouse or other pointing input device (e.g., a touch screen) to make selections from pre-set options in drop-down menus and/or sets of checkboxes and/or radio buttons or the like.

The inventors have recognized, however, that while some clinicians may appreciate the ability to directly enter structured data into an EHR through a point-and-click interface, many clinicians may prefer being unconstrained in what they can say and in what terms they can use in a free-form note, and many may be reluctant to take the time to learn where all the boxes and buttons are and what they all mean in an EHR user interface. In addition, many clinicians may prefer to take advantage of the time savings that can be gained by providing notes through verbal dictation, as speech can often be a faster form of data communication than typing or clicking through forms.

Accordingly, some embodiments described herein relate to techniques for enhancing the creation and use of structured electronic medical records, using techniques that enable a clinician to provide input and observations via a free-form narrative clinician's note. Some embodiments involve the automatic extraction by a clinical language understanding (CLU) system of discrete medical facts (e.g., clinical facts), such as could be stored as discrete structured data items in an electronic medical record, from a clinician's free-form narration of a patient encounter. In this manner, free-form input may be provided, but the advantages of storage, maintenance and accessing of medical documentation data in electronic forms may be maintained. For example, the storage of a patient's medical documentation data as a collection of discrete structured data items may provide the benefits of being able to query for individual data items of interest, and being able to assemble arbitrary subsets of the patient's data items into new reports, orders, invoices, etc., in an automated and efficient manner. In some embodiments, medical documentation may be provided in reports that contain a mix of narrative and structured information, and medical facts may be extracted automatically from both narrative and structured portions of a document, with or without prior designation of the locations of boundaries between structured and unstructured portions.

Automatic extraction of medical facts (e.g., clinical facts) from a free-form narration or other portion of medical documentation may be performed in any suitable way using any suitable technique(s) in some embodiments. Examples of suitable automatic fact extraction techniques are described below. In some embodiments, pre-processing may be performed on a free-form narration prior to performing automatic fact extraction, to determine the sequence of words represented by the free-form narration. Such pre-processing may also be performed in any suitable way using any suitable technique(s) in some embodiments. For example, in some embodiments, the clinician may provide the free-form narration directly in textual form (e.g., using a keyboard or other text entry device), and the textual free-form narration may be automatically parsed to determine its sequence of words. In other embodiments, the clinician may provide the free-form narration in audio form as a spoken dictation, and an audio recording of the clinician's spoken dictation may be received and/or stored. The audio input may be processed in any suitable way prior to or in the process of performing fact extraction, as embodiments are not limited in this respect. In some embodiments, the audio input may be processed to form a textual representation, and fact extraction may be performed on the textual representation. Such processing to produce a textual representation may be performed in any suitable way. For example, in some embodiments, the audio recording may be transcribed by a human transcriptionist, while in other embodiments, automatic speech recognition (ASR) may be performed on the audio recording to obtain a textual representation of the free-form narration provided via the clinician's dictation. Any suitable automatic speech recognition technique may be used, as embodiments are not limited in this respect. In other embodiments, speech-to-text conversion of the clinician's audio dictation may not be required, as a technique that does not involve processing the audio to produce a textual representation may be used to determine what was spoken. In one example, the sequence of words that was spoken may be determined directly from the audio recording, e.g., by comparing the audio recording to stored waveform templates to determine the sequence of words. In other examples, the clinician's speech may not be recognized as words, but may be recognized in another form such as a sequence or collection of abstract concepts. It should be appreciated that the words and/or concepts represented in the clinician's free-form narration may be represented and/or stored as data in any suitable form, including forms other than a textual representation, as aspects of the present invention are not limited in this respect.

In some embodiments, one or more medical facts (e.g., clinical facts) may be automatically extracted from the free-form narration (in audio or textual form) or from a pre-processed data representation of the free-form narration using a fact extraction component applying natural language understanding techniques, such as a natural language understanding (NLU) engine. In some embodiments, the medical facts to be extracted may be defined by a set of fact categories (also referred to herein as “fact types” or “entity types”) commonly used by clinicians in documenting patient encounters. In some embodiments, a suitable set of fact categories may be defined by any of various known healthcare standards. For example, in some embodiments, the medical facts to be extracted may include facts that are required to be documented by Meaningful Use standards promulgated by the U.S. government, e.g., under 42 C.F.R. §495, which sets forth “Objectives” specifying items of medical information to be recorded for medical patients. Such facts currently required by the Meaningful Use standards include social history facts, allergy facts, diagnostic test result facts, medication facts, problem facts, procedure facts, and vital sign facts. However, these are merely exemplary, as aspects of the invention are not limited to any particular set of fact categories. Some embodiments may not use one or more of the above-listed fact categories, and some embodiments may use any other suitable fact categories. Other non-limiting examples of suitable categories of medical facts include findings, disorders, body sites, medical devices, subdivided categories such as observable findings and measurable findings, etc. The fact extraction component may be implemented in any suitable form; exemplary implementations for a fact extraction component are described in detail below.

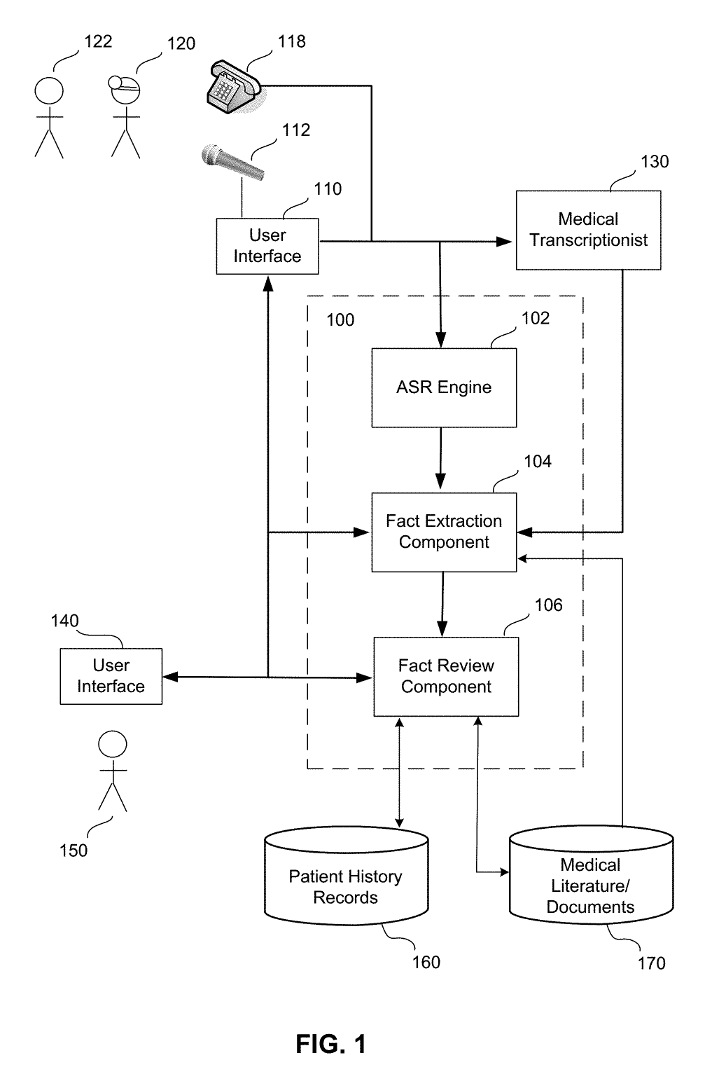

Some embodiments described herein may make use of a clinical language understanding (CLU) system; an exemplary operating environment for using such a CLU system in a medical documentation process is illustrated in FIG. 1. CLU system 100, illustrated in one exemplary implementation in FIG. 1, may be implemented in any suitable form, as embodiments are not limited in this respect. For example, system 100 may be implemented as a single stand-alone machine, or may be implemented by multiple distributed machines that share processing tasks in any suitable manner. System 100 may be implemented as one or more computers; an example of a suitable computer is described below. In some embodiments, system 100 may include one or more tangible, non-transitory computer-readable storage devices storing processor-executable instructions, and one or more processors that execute the processor-executable instructions to perform functions described herein. The storage devices may be implemented as computer-readable storage media encoded with the processor-executable instructions; examples of suitable computer-readable storage media are discussed below.

As depicted, exemplary system 100 includes an ASR engine 102, a fact extraction component 104, and a fact review component 106. Each of these processing components of system 100 may be implemented in software, hardware, or a combination of software and hardware. Components implemented in software may comprise sets of processor-executable instructions that may be executed by the one or more processors of system 100 to perform functionality described herein. Each of ASR engine 102, fact extraction component 104 and fact review component 106 may be implemented as a separate component of system 100, or any combination of these components may be integrated into a single component or a set of distributed components. In addition, any one of ASR engine 102, fact extraction component 104 and fact review component 106 may be implemented as a set of multiple software and/or hardware components. It should be understood that any such component depicted in FIG. 1 is not limited to any particular software and/or hardware implementation and/or configuration. Also, not all components of exemplary system 100 illustrated in FIG. 1 are required in all embodiments. For example, in some embodiments, a CLU system may include functionality of fact extraction component 104, which may be implemented using a natural language understanding (NLU) engine, without including ASR engine 102 and/or fact review component 106.

In the example illustrated in FIG. 1, user interface 110 is presented to a clinician 120, who may be a physician, a physician's aide, a nurse, or any other personnel involved in the evaluation and/or treatment of a patient 122 in a clinical setting. During the course of a clinical encounter with patient 122, or at some point thereafter, clinician 120 may document the patient encounter. Such a patient encounter may include any interaction between clinician 120 and patient 122 in a clinical evaluation and/or treatment setting, including, but not limited to, an office visit, an interaction during hospital rounds, an outpatient or inpatient procedure (surgical or non-surgical), a follow-up evaluation, a visit for laboratory or radiology testing, etc. For an inpatient visit such as a hospital stay, a patient encounter may encompass the entire stay and may include multiple sub-encounters with various different clinicians and could involve multiple procedures.

One method that clinician 120 may use to document the patient encounter may be to enter medical facts that can be ascertained from the patient encounter into user interface 110 as discrete structured data items. The set of medical facts, once entered, may be transmitted in some embodiments via any suitable communication medium or media (e.g., local and/or network connection(s) that may include wired and/or wireless connection(s)) to system 100. Specifically, in some embodiments, the set of medical facts may be received at system 100 by a fact review component 106, exemplary functions of which are described below.

Another method that may be used by clinician 120 to document the patient encounter is to provide a free-form narration of the patient encounter. In some embodiments, the narration may be free-form in the sense that clinician 120 may be unconstrained with regard to the structure and content of the narration, and may be free to provide any sequence of words, sentences, paragraphs, sections, etc., that he would like. In some embodiments, there may be no limitation on the length of the free-form narration, or the length may be limited only by the processing capabilities of the user interface into which it is entered or of the later processing components that will operate upon it. In other embodiments, the free-form narration may be constrained in length (e.g., limited to a particular number of characters).

A free-form narration of the patient encounter may be provided by clinician 120 in any of various ways. One way may be to manually enter the free-form narration in textual form into user interface 110, e.g., using a keyboard. In this respect, the one or more processors of system 100 and/or of a client device in communication with system 100 may in some embodiments be programmed to present a user interface including a text editor/word processor to clinician 120. Such a text editor/word processor may be implemented in any suitable way, as embodiments are not limited in this respect. Another way to provide a free-form narration of the patient encounter may be to verbally speak a dictation of the patient encounter. Such a spoken dictation may be provided in any suitable way, as embodiments are not limited in this respect. As illustrated in FIG. 1, one way that clinician 120 may provide a spoken dictation of the free-form narration may be to speak the dictation into a microphone 112 providing input (e.g., via a direct wired connection, a direct wireless connection, or via a connection through an intermediate device) to user interface 110. An audio recording of the spoken dictation may then be stored in any suitable data format, and transmitted to system 100 and/or to medical transcriptionist 130. Another way that clinician 120 may provide the spoken dictation may be to speak into a telephone 118, from which an audio signal may be transmitted to be recorded at system 100, at the site of medical transcriptionist 130, or at any other suitable location. Alternatively, the audio signal may be recorded in any suitable data format at an intermediate facility, and the audio data may then be relayed to system 100 and/or to medical transcriptionist 130.

In some embodiments, medical transcriptionist 130 may receive the audio recording of the dictation provided by clinician 120, and may transcribe it into a textual representation of the free-form narration (e.g., into a text narrative). Medical transcriptionist 130 may be any human who listens to the audio dictation and writes or types what was spoken into a text document. In some embodiments, medical transcriptionist 130 may be specifically trained in the field of medical transcription, and may be well-versed in medical terminology. In some embodiments, medical transcriptionist 130 may transcribe exactly what she hears in the audio dictation, while in other embodiments, medical transcriptionist 130 may add formatting to the text transcription to comply with generally accepted medical document standards. When medical transcriptionist 130 has completed the transcription of the free-form narration into a textual representation, the resulting text narrative may in some embodiments be transmitted to system 100 or any other suitable location (e.g., to a storage location accessible to system 100). Specifically, in some embodiments the text narrative may be received from medical transcriptionist 130 by fact extraction component 104 within system 100. Exemplary functionality of fact extraction component 104 is described below.

In some other embodiments, the audio recording of the spoken dictation may be received, at system 100 or any other suitable location, by automatic speech recognition (ASR) engine 102. In some embodiments, ASR engine 102 may then process the audio recording to determine what was spoken. As discussed above, such processing may involve any suitable speech recognition technique, as embodiments are not limited in this respect. In some embodiments, the audio recording may be automatically converted to a textual representation, while in other embodiments, words identified directly from the audio recording may be represented in a data format other than text, or abstract concepts may be identified instead of words. Examples of further processing are described below with reference to a text narrative that is a textual representation of the free-form narration; however, it should be appreciated that similar processing may be performed on other representations of the free-form narration as discussed above. When a textual representation is produced, in some embodiments it may be reviewed by a human (e.g., a transcriptionist) for accuracy, while in other embodiments the output of ASR engine 102 may be accepted as accurate without human review. As discussed above, some embodiments are not limited to any particular method for transcribing audio data; an audio recording of a spoken dictation may be transcribed manually by a human transcriptionist, automatically by ASR, or semiautomatically by human editing of a draft transcription produced by ASR. Transcriptions produced by ASR engine 102 and/or by transcriptionist 130 may be encoded or otherwise represented as data in any suitable form, as embodiments are not limited in this respect.

In some embodiments, ASR engine 102 may make use of a lexicon of medical terms (which may be part of, or in addition to, another more general speech recognition lexicon) while determining the sequence of words that were spoken in the free-form narration provided by clinician 120. However, embodiments are not limited to the use of a lexicon, or any particular type of lexicon, for ASR. When used, the medical lexicon in some embodiments may be linked to a knowledge representation model such as a clinical language understanding ontology utilized by fact extraction component 104, such that ASR engine 102 might produce a text narrative containing terms in a form understandable to fact extraction component 104. In some embodiments, a more general speech recognition lexicon might also be shared between ASR engine 102 and fact extraction component 104. However, in other embodiments, ASR engine 102 may not have any lexicon developed to be in common with fact extraction component 104. In some embodiments, a lexicon used by ASR engine 102 may be linked to a different type of medical knowledge representation model, such as one not designed or used for language understanding. It should be appreciated that any lexicon used by ASR engine 102 and/or fact extraction component 104 may be implemented and/or represented as data in any suitable way, as aspects of the invention are not limited in this respect.

In some embodiments, a text narrative, whether produced by ASR engine 102 (and optionally verified or not by a human), produced by medical transcriptionist 130, directly entered in textual form through user interface 110, or produced in any other way, may be re-formatted in one or more ways before being received by fact extraction component 104. Such re-formatting may be performed by ASR engine 102, by a component of fact extraction component 104, by a combination of ASR engine 102 and fact extraction component 104, or by any other suitable software and/or hardware component. In some embodiments, the re-formatting may be performed in a way known to facilitate fact extraction, and may be performed for the purpose of facilitating the extraction of clinical facts from the text narrative by fact extraction component 104. For example, in some embodiments, processing to perform fact extraction may be improved if sentence boundaries in the text narrative are accurate. Accordingly, in some embodiments, the text narrative may be re-formatted prior to fact extraction to add, remove or correct one or more sentence boundaries within the text narrative. In some embodiments, this may involve altering the punctuation in at least one location within the text narrative. In another example, fact extraction may be improved if the text narrative is organized into sections with headings, and thus the re-formatting may include determining one or more section boundaries in the text narrative and adding, removing or correcting one or more corresponding section headings. In some embodiments, the re-formatting may include normalizing one or more section headings (which may have been present in the original text narrative and/or added or corrected as part of the re-formatting) according to a standard for the healthcare institution corresponding to the patient encounter (which may be an institution-specific standard or a more general standard for section headings in clinical documents). In some embodiments, a user (such as clinician 120, medical transcriptionist 130, or another user) may be prompted to approve the re-formatted text.

In some embodiments, either an original or a re-formatted text narrative may be received by fact extraction component 104, which may perform processing to extract one or more medical facts (e.g., clinical facts) from the text narrative. The text narrative may be received from ASR engine 102, from medical transcriptionist 130, directly from clinician 120 via user interface 110, or in any other suitable way. Any suitable technique(s) for extracting facts from the text narrative may be used in some embodiments. Exemplary techniques for medical fact extraction are described below.

In some embodiments, a fact extraction component may be implemented using techniques such as those described in U.S. Pat. No. 7,493,253, entitled “Conceptual World Representation Natural Language Understanding System and Method.” U.S. Pat. No. 7,493,253 is incorporated herein by reference in its entirety. Such a fact extraction component may make use of a formal ontology linked to a lexicon of clinical terms. The formal ontology may be implemented as a relational database, or in any other suitable form, and may represent semantic concepts relevant to the medical domain, as well as linguistic concepts related to ways the semantic concepts may be expressed in natural language.

In some embodiments, concepts in a formal ontology used by a fact extraction component may be linked to a lexicon of medical terms and/or codes, such that each medical term and each code is linked to at least one concept in the formal ontology. In some embodiments, the lexicon may include the standard medical terms and/or codes used by the institution in which the fact extraction component is applied. For example, the standard medical terms and/or codes used by an EHR maintained by the institution may be included in the lexicon linked to the fact extraction component's formal ontology. In some embodiments, the lexicon may also include additional medical terms used by the various clinicians within the institution, and/or used by clinicians generally, when describing medical issues in a free-form narration. Such additional medical terms may be linked, along with their corresponding standard medical terms, to the appropriate shared concepts within the formal ontology. For example, the standard term “acute myocardial infarction” as well as other corresponding terms such as “heart attack”, “acute MI” and “AMI” may all be linked to the same abstract concept in the formal ontology—a concept representing an interruption of blood supply to the heart. Such linkage of multiple medical terms to the same abstract concept in some embodiments may relieve the clinician of the burden of ensuring that only standard medical terms preferred by the institution appear in the free-form narration. For example, in some embodiments, a clinician may be free to use the abbreviation “AMI” or the colloquial “heart attack” in his free-form narration, and the shared concept linkage may allow the fact extraction component to nevertheless automatically extract a fact corresponding to “acute myocardial infarction”.

In some embodiments, a formal ontology used by a fact extraction component may also represent various types of relationships between the concepts represented. One type of relationship between two concepts may be a parent-child relationship, in which the child concept is a more specific version of the parent concept. More formally, in a parent-child relationship, the child concept inherits all necessary properties of the parent concept, while the child concept may have necessary properties that are not shared by the parent concept. For example, “heart failure” may be a parent concept, and “congestive heart failure” may be a child concept of “heart failure.” In some embodiments, any other type(s) of relationship useful to the process of medical documentation may also be represented in the formal ontology. For example, one type of relationship may be a symptom relationship. In one example of a symptom relationship, a concept linked to the term “chest pain” may have a relationship of “is-symptom-of” to the concept linked to the term “heart attack”. Other types of relationships may include complication relationships, comorbidity relationships, interaction relationships (e.g., among medications), and many others. Any number and type(s) of concept relationships may be included in such a formal ontology, as embodiments are not limited in this respect. In some embodiments, automatic extraction of medical facts from a clinician's free-form narration may involve parsing the free-form narration to identify medical terms that are represented in the lexicon of the fact extraction component. Concepts in the formal ontology linked to the medical terms that appear in the free-form narration may then be identified, and concept relationships in the formal ontology may be traced to identify further relevant concepts. Through these relationships, as well as the linguistic knowledge represented in the formal ontology, one or more medical facts may be extracted. For example, if the free-form narration includes the medical term “hypertension” and the linguistic context relates to the patient's past, the fact extraction component may automatically extract a fact indicating that the patient has a history of hypertension. On the other hand, if the free-form narration includes the medical term “hypertension” in a sentence about the patient's mother, the fact extraction component may automatically extract a fact indicating that the patient has a family history of hypertension. In some embodiments, relationships between concepts in the formal ontology may also allow the fact extraction component to automatically extract facts containing medical terms that were not explicitly included in the free-form narration. For example, the medical term “meningitis” can also be described as inflammation in the brain. If the free-form narration includes the terms “inflammation” and “brain” in proximity to each other, then relationships in the formal ontology between concepts linked to the terms “inflammation”, “brain” and “meningitis” may allow the fact extraction component to automatically extract a fact corresponding to “meningitis”, despite the fact that the term “meningitis” was not stated in the free-form narration.

It should be appreciated that the foregoing descriptions are provided by way of example only, and that any suitable technique(s) for extracting a set of one or more medical facts from a free-form narration may be used in some embodiments. For instance, it should be appreciated that fact extraction component 104 is not limited to the use of an ontology, as other forms of knowledge representation models, including statistical models and/or rule-based models, may also be used. The knowledge representation model may also be represented as data in any suitable format, and may be stored in any suitable location, such as in a storage medium of system 100 accessible by fact extraction component 104, as embodiments are not limited in this respect. In addition, a knowledge representation model such as an ontology used by fact extraction component 104 may be constructed in any suitable way, as embodiments are not limited in this respect.

For instance, in some embodiments a knowledge representation model may be constructed manually by one or more human developers with access to expert knowledge about medical facts, diagnoses, problems, potential complications, comorbidities, appropriate observations and/or clinical findings, and/or any other relevant information. In other embodiments, a knowledge representation model may be generated automatically, for example through statistical analysis of past medical reports documenting patient encounters, of medical literature and/or of other medical documents. Thus, in some embodiments, fact extraction component 104 may have access to a data set 170 of medical literature and/or other documents such as past patient encounter reports. In some embodiments, past reports and/or other text documents may be marked up (e.g., by a human) with labels indicating the nature of the relevance of particular statements in the text to the patient encounter or medical topic to which the text relates. A statistical knowledge representation model may then be trained to form associations based on the prevalence of particular labels corresponding to similar text within an aggregate set of multiple marked up documents. For example, if “pneumothorax” is labeled as a “complication” in a large enough proportion of clinical procedure reports documenting pacemaker implantation procedures, a statistical knowledge representation model may generate and store a concept relationship that “pneumothorax is-complication-of pacemaker implantation.” In some embodiments, automatically generated and hard coded (e.g., by a human developer) concepts and/or relationships may both be included in a knowledge representation model used by fact extraction component 104.

As discussed above, it should be appreciated that embodiments are not limited to any particular technique(s) for constructing knowledge representation models. Examples of suitable techniques include those disclosed in the following:

Gómez-Pérez, A., and Manzano-Macho, D. (2005). An overview of methods and tools for ontology learning from texts. Knowledge Engineering Review 19, p. 187-212.

Cimiano, P., and Staab, S. (2005). Learning concept hierarchies from text with a guided hierarchical clustering algorithm. In C. Biemann and G. Paas (eds.), Proceedings of the ICML 2005 Workshop on Learning and Extending Lexical Ontologies with Machine Learning Methods, Bonn, Germany.

Fan, J., Ferrucci, D., Gondek, D., and Kalyanpur, A. (2010). PRISMATIC: Inducing Knowledge from a Lange Scale Lexicalized Relation Resource. NAACL Workshop on Formalisms and Methodology for Learning by Reading.

Welty, C., Fan, J., Gondek, D. and Schlaikjer, A. (2010). Large scale relation detection. NAACL Workshop on Formalisms and Methodology for Learning by Reading.

Each of the foregoing publications is incorporated herein by reference in its entirety.

Alternatively or additionally, in some embodiments a fact extraction component may make use of one or more statistical classifier models to extract semantic entities from natural language input. In general, a statistical model can be described as a functional component designed and/or trained to analyze new inputs based on probabilistic patterns observed in prior training inputs. In this sense, statistical models differ from “rule-based” models, which typically apply hard-coded deterministic rules to map from inputs having particular characteristics to particular outputs. By contrast, a statistical model may operate to determine a particular output for an input with particular characteristics by considering how often (e.g., with what probability) training inputs with those same characteristics (or similar characteristics) were associated with that particular output in the statistical model's training data. To supply the probabilistic data that allows a statistical model to extrapolate from the tendency of particular input characteristics to be associated with particular outputs in past examples, statistical models are typically trained (or “built”) on large training corpuses with great numbers of example inputs. Typically the example inputs are labeled with the known outputs with which they should be associated, usually by a human labeler with expert knowledge of the domain. Characteristics of interest (known as “features”) are identified (“extracted”) from the inputs, and the statistical model learns the probabilities with which different features are associated with different outputs, based on how often training inputs with those features are associated with those outputs. When the same features are extracted from a new input (e.g., an input that has not been labeled with a known output by a human), the statistical model can then use the learned probabilities for the extracted features (as learned from the training data) to determine which output is most likely correct for the new input. Exemplary implementations of a fact extraction component using one or more statistical models are described further below.

In some embodiments, fact extraction component 104 may utilize a statistical fact extraction model based on entity detection and/or tracking techniques, such as those disclosed in: Florian, R., Hassan, H., Ittycheriah, A., Jing, H., Kambhatla, N., Luo, X., Nicolov, N., and Roukos, S. (2004). A Statistical Model for Multilingual Entity Detection and Tracking. Proceedings of the Human Language Technologies Conference 2004 (HLT-NAACL '04). This publication is incorporated herein by reference in its entirety.

For example, in some embodiments, a list of fact types of interest for generating medical reports may be defined, e.g., by a developer of fact extraction component 104. Such fact types (also referred to herein as “entity types”) may include, for example, problems, disorders (a disorder is a type of problem), diagnoses (a diagnosis may be a disorder that a clinician has identified as a problem for a particular patient), findings (a finding is a type of problem that need not be a disorder), medications, body sites, social history facts, allergies, diagnostic test results, vital signs, procedures, procedure steps, observations, devices, and/or any other suitable medical fact types. It should be appreciated that any suitable list of fact types may be utilized, and may or may not include any of the fact types listed above, as embodiments are not limited in this respect. In some embodiments, spans of text in a set of sample patient encounter reports may be labeled (e.g., by a human) with appropriate fact types from the list. A statistical model may then be trained on the corpus of labeled sample reports to detect and/or track such fact types as semantic entities, using entity detection and/or tracking techniques, examples of which are described below.

For example, in some embodiments, a large number of past free-form narrations created by clinicians may be manually labeled to form a corpus of training data for a statistical entity detection model. As discussed above, in some embodiments, a list of suitable entities may be defined (e.g., by a domain administrator) to include medical fact types that are to be extracted from future clinician narrations. One or more human labelers (e.g., who may have specific knowledge about medical information and typical clinician narration content) may then manually label portions of the training texts with the particular defined entities to which they correspond. For example, given the training text, “Patient is complaining of acute sinusitis,” a human labeler may label the text portion “acute sinusitis” with the entity label “Problem.” In another example, given the training text, “He has sinusitis, which appears to be chronic,” a human labeler may label the text “sinusitis” and “chronic” with a single label indicating that both words together correspond to a “Problem” entity. As should be clear from these examples, the portion of the text labeled as corresponding to a single conceptual entity need not be formed of contiguous words, but may have words split up within the text, having non-entity words in between.

In some embodiments, the labeled corpus of training data may then be processed to build a statistical model trained to detect mentions of the entities labeled in the training data. Each time the same conceptual entity appears in a text, that appearance is referred to as a mention of that entity. For example, consider the text, “Patient has sinusitis. His sinusitis appears to be chronic.” In this example, the entity detection model may be trained to identify each appearance of the word “sinusitis” in the text as a separate mention of the same “Problem” entity.

In some embodiments, the process of training a statistical entity detection model on labeled training data may involve a number of steps to analyze each training text and probabilistically associate its characteristics with the corresponding entity labels. In some embodiments, each training text (e.g., free-form clinician narration) may be tokenized to break it down into various levels of syntactic substructure. For example, in some embodiments, a tokenizer module may be implemented to designate spans of the text as representing structural/syntactic units such as document sections, paragraphs, sentences, clauses, phrases, individual tokens, words, sub-word units such as affixes, etc. In some embodiments, individual tokens may often be single words, but some tokens may include a sequence of more than one word that is defined, e.g., in a dictionary, as a token. For example, the term “myocardial infarction” could be defined as a token, although it is a sequence of more than one word. In some embodiments, a token's identity (i.e., the word or sequence of words itself) may be used as a feature of that token. In some embodiments, the token's placement within particular syntactic units in the text (e.g., its section, paragraph, sentence, etc.) may also be used as features of the token.

In some embodiments, an individual token within the training text may be analyzed (e.g., in the context of the surrounding sentence) to determine its part of speech (e.g., noun, verb, adjective, adverb, preposition, etc.), and the token's part of speech may be used as a further feature of that token. In some embodiments, each token may be tagged with its part of speech, while in other embodiments, not every token may be tagged with a part of speech. In some embodiments, a list of relevant parts of speech may be pre-defined, e.g., by a developer of the statistical model, and any token having a part of speech listed as relevant may be tagged with that part of speech. In some embodiments, a parser module may be implemented to determine the syntactic structure of sentences in the text, and to designate positions within the sentence structure as features of individual tokens. For example, in some embodiments, the fact that a token is part of a noun phrase or a verb phrase may be used as a feature of that token. Any type of parser may be used, non-limiting examples of which include a bottom-up parser and/or a dependency parser, as aspects of the invention are not limited in this respect. In some embodiments, section membership may be used as a feature of a token.

In some embodiments, a section normalization module may be implemented to associate various portions of the narrative text with the proper section(s) to which they should belong. In some embodiments, a set of standardized section types (e.g., identified by their section headings) may be defined for all texts, or a different set of normalized section headings may be defined for each of a number of different types of texts (e.g., corresponding to different types of documents). For example, in some embodiments, a different set of normalized section headings may be defined for each type of medical document in a defined set of medical document types. Non-limiting examples of medical document types include consultation reports, history & physical reports, discharge summaries, and emergency room reports, although there are also many other examples. In the medical field, the various types of medical documents are often referred to as “work types.” In some cases, the standard set of sections for various types of medical documents may be established by a suitable system standard, institutional standard, or more widely applicable standard, such as the Meaningful Use standard (discussed above) or the Logical Observation Identifiers Names and Codes (LOINC) standard maintained by the Regenstrief Institute. For example, an expected set of section headings for a history & physical report under the Meaningful Use standard may include headings for a “Reason for Visit” section, a “History of Present Illness” section, a “History of Medication Use” section, an “Allergies, Adverse Reactions and Alerts” section, a “Review of Systems” section, a “Social History” section, a “Physical Findings” section, an “Assessment and Plan” section, and/or any other suitable section(s). Any suitable set of sections may be used, however, as embodiments are not limited in this respect.

A section normalization module may use any suitable technique to associate portions of text with normalized document sections, as embodiments are not limited in this respect. In some embodiments, the section normalization module may use a table (e.g., stored as data in a storage medium) to map text phrases that commonly occur in medical documents to the sections to which they should belong. In another example, a statistical model may be trained to determine the most likely section for a portion of text based on its semantic content, the semantic content of surrounding text portions, and/or the expected semantic content of the set of normalized sections. In some embodiments, once a normalized section for a portion of text has been identified, the membership in that section may be used as a feature of one or more tokens in that portion of text.

In some embodiments, other types of features may be extracted, i.e., identified and associated with tokens in the training text. For example, in some embodiments, an N-gram feature may identify the previous (N-1) words and/or tokens in the text as a feature of the current token. In another example, affixes (e.g., suffixes such as -ectomy, -oma, -itis, etc.) may be used as features of tokens. In another example, one or more predefined dictionaries (and/or ontologies, etc.) may be accessed, and a token's membership in any of those dictionaries may be used as a feature of that token. For example, a predefined dictionary of surgical procedures may be accessed, and/or a dictionary of body sites, and/or a dictionary of known diseases, etc. It should be appreciated, however, that all of the foregoing feature types are merely examples, and any suitable number and/or types of features of interest may be designated, e.g., by a developer of the statistical entity detection model, as embodiments are not limited in this respect.

In some embodiments, the corpus of training text with its hand-labeled fact type entity labels, along with the collection of features extracted for tokens in the text, may be input to the statistical entity detection model for training. As discussed above, examples of suitable features include position within document structure, syntactic structure, parts of speech, parser features, N-gram features, affixes (e.g., prefixes and/or suffixes), membership in dictionaries (sometimes referred to as “gazetteers”) and/or ontologies, surrounding token contexts (e.g., a certain number of tokens to the left and/or right of the current token), orthographic features (e.g., capitalization, letters vs. numbers, etc.), entity labels assigned to previous tokens in the text, etc. As one non-limiting example, consider the training sentence, “Patient is complaining of acute sinusitis,” for which the word sequence “acute sinusitis” was hand-labeled as being a “Problem” entity. In one exemplary implementation, features extracted for the token “sinusitis” may include the token identity feature that the word is “sinusitis,” a syntactic feature specifying that the token occurred at the end of a sentence (e.g., followed by a period), a part-of-speech feature of “noun,” a parser feature that the token is part of a noun phrase (“acute sinusitis”), a trigram feature that the two preceding words are “of acute,” an affix feature of “-itis,” and a dictionary feature that the token is a member of a predefined dictionary of types of inflammation. It should be appreciated, however, that the foregoing list of features is merely exemplary, as any suitable features may be used. Embodiments are not limited to any of the features listed above, and implementations including some, all, or none of the above features, as well as implementations including features not listed above, are possible.

In some embodiments, given the extracted features and manual entity labels for the entire training corpus as input, the statistical entity detection model may be trained to be able to probabilistically label new texts (e.g., texts not included in the training corpus) with automatic entity labels using the same feature extraction technique that was applied to the training corpus. In other words, by processing the input features and manual entity labels of the training corpus, the statistical model may learn probabilistic relationships between the features and the entity labels. When later presented with an input text without manual entity labels, the statistical model may then apply the same feature extraction techniques to extract features from the input text, and may apply the learned probabilistic relationships to automatically determine the most likely entity labels for word sequences in the input text. Any suitable statistical modeling technique may be used to learn such probabilistic relationships, as embodiments are not limited in this respect. Non-limiting examples of suitable known statistical modeling techniques include machine learning techniques such as maximum entropy modeling, support vector machines, and conditional random fields, among others.

In some embodiments, training the statistical entity detection model may involve learning, for each extracted feature, a probability with which tokens having that feature are associated with each entity type. For example, for the suffix feature “-itis,” the trained statistical entity detection model may store a probability p1 that a token with that feature should be labeled as being part of a “Problem” entity, a probability p2 that a token with that feature should be labeled as being part of a “Medication” entity, etc. In some embodiments, such probabilities may be learned by determining the frequency with which tokens having the “-itis” feature were hand-labeled with each different entity label in the training corpus. In some embodiments, the probabilities may be normalized such that, for each feature, the probabilities of being associated with each possible entity (fact type) may sum to 1. However, embodiments are not limited to such normalization. In some embodiments, each feature may also have a probability p0 of not being associated with any fact type, such that the non-entity probability p0 plus the probabilities of being associated with each possible fact type sum to 1 for a given feature. In other embodiments, separate classifiers may be trained for each fact type, and the classifiers may be run in parallel. For example, the “-itis” feature may have probability p1 of being part of a “Problem” entity and probability (1—p1) of not being part of a “Problem” entity, probability p2 of being part of a “Medication” entity and probability (1—p2) of not being part of a “Medication” entity, and so on. In some embodiments, training separate classifiers may allow some word sequences to have a non-zero probability of being labeled with more than one fact type simultaneously; for example, “kidney failure” could be labeled as representing both a Body Site and a Problem. In some embodiments, classifiers may be trained to identify sub-portions of an entity label. For example, the feature “-itis” could have a probability p_{B} of its token being at the beginning of a “Problem” entity label, a probability p_{I} of its token being inside a “Problem” entity label (but not at the beginning of the label), and a probability pₒ of its token being outside a “Problem” entity label (i.e., of its token not being part of a “Problem” entity). In some embodiments, the probabilities learned from the training data for different feature-classification combinations may be stored in an index for later retrieval when applying the learned probabilities to classify an entity in a new input text.

In some embodiments, the statistical entity detection model may be further trained to weight the individual features of a token to determine an overall probability that it should be associated with a particular entity label. For example, if the token “sinusitis” has n extracted features f1 . . . fn having respective probabilities p1 . . . pn of being associated with a “Problem” entity label, the statistical model may be trained to apply respective weights w1 . . . wn to the feature probabilities, and then combine the weighted feature probabilities in any suitable way to determine the overall probability that “sinusitis” should be part of a “Problem” entity. Any suitable technique for determining such weights may be used, including known modeling techniques such as maximum entropy modeling, support vector machines, conditional random fields, and/or others, as embodiments are not limited in this respect.

In some embodiments, when an unlabeled text is input to the trained statistical entity detection model, the model may process the text to extract features and determine probabilities for individual tokens of being associated with various entity (e.g., fact type) labels. In some embodiments, a probability of an individual token being a particular entity type may be computed by extracting the entity detection model's defined set of features from that token, retrieving the associated probabilities for each entity type for each extracted feature (e.g., as previously computed and stored in an index), and combining the probabilities for all of the features (e.g., applying the entity detection model's defined set of feature weights) to compute a combined probability for each entity type for the token. In some embodiments, the most probable label (including the non-entity label, if it is most probable) may be selected for each token in the input text. In other embodiments, labels may be selected through more contextual analysis, such as at the phrase level or sentence level, rather than at the token level. Any suitable technique, such as Viterbi techniques, or any other suitable technique, may be used, as embodiments are not limited in this respect. In some embodiments, a lattice may be constructed of the associated probabilities for all entity types for all tokens in a sentence, and the best (e.g., highest combined probability) path through the lattice may be selected to determine which word sequences in the sentence are to be automatically labeled with which entity (e.g., fact type) labels. In some embodiments, not only the best path may be identified, but also the (N-1)-best alternative paths with the next highest associated probabilities. In some embodiments, this may result in an N-best list of alternative hypotheses for fact type labels to be associated with the same input text.

In some embodiments, a statistical model may also be trained to associate fact types extracted from new reports with particular facts to be extracted from those reports (e.g., to determine a particular concept represented by the text portion that has been labeled as an entity mention). For example, in some embodiments, a statistical fact extraction model may be applied to automatically label “acute sinusitis” not only with the “Problem” entity (fact type) label, but also with a label indicating the particular medical fact (e.g., concept) indicated by the word sequence (e.g., the medical fact “sinusitis, acute”). In such embodiments, for example, a single statistical model may be trained to detect specific particular facts as individual entities. For example, in some embodiments, the corpus of training text may be manually labeled by one or more human annotators with labels indicating specific medical facts, rather than labels indicating more general entities such as fact types or categories. However, in other embodiments, the process of detecting fact types as entities may be separated from the process of relating detected fact types to particular facts. For example, in some embodiments, a separate statistical model (e.g., an entity detection model) may be trained to automatically label portions of text with fact type labels, and another separate statistical model (e.g., a relation model) may be trained to identify which labeled entity (fact type) mentions together indicate a single specific medical fact. In some cases, the relation model may identify particular medical facts by relating together two or more mentions labeled with the same entity type. Alternatively or additionally, in some embodiments a relation model may identify two or more different medical facts in a text as having a particular relation to each other, such as a Problem fact being caused by a Social History fact (e.g., pulmonary disease is caused by smoking), or a Problem fact being treated by a Medication fact (e.g., bacterial infection is treated by antibiotic), etc.

For example, in the text, “Patient is complaining of acute sinusitis,” in some embodiments an entity detection model may label the tokens “acute” and “sinusitis” as being part of a “Problem” entity. In some embodiments, a relation model, given that “acute” and “sinusitis” have been labeled as “Problem,” may then relate the two tokens together to a single medical fact of “sinusitis, acute.” For another example, consider the text, “Patient has sinusitis, which appears to be chronic.” In some embodiments, an entity detection model may be applied to label the tokens “sinusitis” and “chronic” as “Problem” entity mentions. In some embodiments, a relation model may then be applied to determine that the two “Problem” entity mentions “sinusitis” and “chronic” are related (even though they are not contiguous in the text) to represent a single medical fact of “sinusitis, chronic.” For yet another example, consider the text, “She has acute sinusitis; chronic attacks of asthma may be a factor.” In some embodiments, an entity detection model may label each of the tokens “acute,” “sinusitis,” “chronic,” and “asthma” as belonging to “Problem” entity mentions. In some embodiments, a relation model may then be applied to determine which mentions relate to the same medical fact. For example, the relation model may determine that the tokens “acute” and “sinusitis” relate to a first medical fact (e.g., “sinusitis, acute”), while the tokens “chronic” and “asthma” relate to a different medical fact (e.g., “asthma, chronic”), even though the token “chronic” is closer in the sentence to the token “sinusitis” than to the token “asthma.”

In some embodiments, a relation model may be trained statistically using methods similar to those described above for training the statistical entity detection model. For example, in some embodiments, training texts may be manually labeled with various types of relations between entity mentions and/or tokens within entity mentions. For example, in the training text, “Patient has sinusitis, which appears to be chronic,” a human annotator may label the “Problem” mention “chronic” as having a relation to the “Problem” mention “sinusitis,” since both mentions refer to the same medical fact. In some embodiments, the relation annotations may simply indicate that certain mentions are related to each other, without specifying any particular type of relationship. In other embodiments, relation annotations may also indicate specific types of relations between entity mentions. Any suitable number and/or types of relation annotations may be used, as embodiments are not limited in this respect. For example, in some embodiments, one type of relation annotation may be a “split” relation label. The tokens “sinusitis” and “chronic,” for example, may be labeled as having a split relationship, because “sinusitis” and “chronic” together make up an entity, even though they are not contiguous within the text. In this case, “sinusitis” and “chronic” together indicate a specific type of sinusitis fact, i.e., one that it is chronic and not, e.g., acute. Another exemplary type of relation may be an “attribute” relation. In some embodiments, one or more system developers may define sets of attributes for particular fact types, corresponding to related information that may be specified for a fact type. For example, a “Medication” fact type may have attributes “dosage,” “route,” “frequency,” “duration,” etc. In another example, an “Allergy” fact type may have attributes “allergen,” “reaction,” “severity,” etc. As further examples, relation annotations for relating two or more facts together may include such annotations as “hasCause,” “hasConcurrenceWith,” “hasTreatment,” and/or any other suitable relation. It should be appreciated, however, that the foregoing are merely examples, and that embodiments are not limited to any particular attributes for any particular fact types. Also, other types of fact relations are possible, including family relative relations, causes-problem relations, improves-problem relations, and many others. Embodiments are not limited to use of any particular relation types.

In some embodiments, using techniques similar to those described above, the labeled training text may be used as input to train the statistical relation model by extracting features from the text, and probabilistically associating the extracted features with the manually supplied labels. Any suitable set of features may be used, as embodiments are not limited in this respect. For example, in some embodiments, features used by a statistical relation model may include entity (e.g., fact type) labels, parts of speech, parser features, N-gram features, token window size (e.g., a count of the number of words or tokens present between two tokens that are being related to each other), and/or any other suitable features. It should be appreciated, however, that the foregoing features are merely exemplary, as embodiments are not limited to any particular list of features. In some embodiments, rather than outputting only the best (e.g., most probable) hypothesis for relations between entity mentions, a statistical relation model may output a list of multiple alternative hypotheses, e.g., with corresponding probabilities, of how the entity mentions labeled in the input text are related to each other. In yet other embodiments, a relation model may be hard-coded and/or otherwise rule-based, while the entity detection model used to label text portions with fact types may be trained statistically.

In some embodiments, the relation model or another statistical model may also be trained to track mentions of the same entity from different sentences and/or document sections and to relate them together. Exemplary techniques for entity tracking are described in the publication by Florian cited above.

In some embodiments, further processing may be applied to normalize particular facts extracted from the text to standard forms and/or codes in which they are to be documented. For example, medical personnel often have many different ways of phrasing the same medical fact, and a normalization/coding process in some embodiments may be applied to identify the standard form and/or code corresponding to each extracted medical fact that was stated in a non-standard way. The standard form and/or code may be derived from any suitable source, as embodiments are not limited in this respect. Some standard terms and/or codes may be derived from a government or profession-wide standard, such as SNOMED (Systematized Nomenclature of Medicine), UMLS (Unified Medical Language System), RxNorm, RadLex, etc. Other standard terms and/or codes may be more locally derived, such as from standard practices of a particular locality or institution. Still other standard terms and/or codes may be specific to the documentation system including the fact extraction component being applied. For example, given the input text, “His sinuses are constantly inflamed,” in some embodiments, an entity detection model together with a relation model (or a single model performing both functions) may identify the tokens “sinuses,” “constantly” and “inflamed” as representing a medical fact. In some embodiments, a normalization/coding process may then be applied to identify the standard form for documenting “constantly inflamed sinuses” as “sinusitis, chronic.” Alternatively or additionally, in some embodiments the normalization/coding process may identify a standard code used to document the identified fact. For example, the ICD-9 code for “sinusitis, chronic” is ICD-9 code #473, and the SNOMED CT concept code for “chronic sinusitis” is 40055000. Any suitable coding system may be used, as embodiments are not limited in this respect. Exemplary standard codes include ICD (International Classification of Diseases) codes, CPT (Current Procedural Terminology) codes, E&M (Evaluation and Management) codes, MedDRA (Medical Dictionary for Regulatory Activities) codes, SNOMED codes, LOINC (Logical Observation Identifiers Names and Codes) codes, RxNorm codes, NDC (National Drug Code) codes and RadLex codes. Some standard coding systems (e.g., ICD codes, CPT codes, etc.) may function as medical billing codes, while others (e.g., SNOMED codes) typically may not. In some embodiments, the normalization/coding process may assign the appropriate corresponding code(s) (e.g., billing codes or other type(s) of normalizing codes) from any one or more suitable medical classification systems to a fact extracted from the medical report text and provide the corresponding code(s) as output.

In some embodiments, a normalization/coding process may be rule-based (e.g., using lists of possible ways of phrasing particular medical facts, and/or using an ontology of medical terms and/or other language units to normalize facts extracted from input text to their standard forms). For example, in some embodiments, the tokens identified in the text as corresponding to a medical fact may be matched to corresponding terms in an ontology. In some embodiments, a list of closest matching terms may be generated, and may be ranked by their similarity to the tokens in the text. The similarity may be scored in any suitable way. For example, in one suitable technique, one or more tokens in the text may be considered as a vector of its component elements, such as words, and each of the terms in the ontology may also be considered as a vector of component elements such as words. Similarity scores between the tokens may then be computed by comparing the corresponding vectors, e.g., by calculating the angle between the vectors, or a related measurement such as the cosine of the angle. In some embodiments, one or more concepts that are linked in the ontology to one or more of the higher ranking terms (e.g., the terms most similar to the identified tokens in the text) may then be identified as hypotheses for the medical fact to be extracted from that portion of the text. Exemplary techniques that may be used in some embodiments are described in Salton, Wong, & Yang: “A vector space model for automatic indexing,” Communications of the ACM, November 1975. This publication is incorporated herein by reference in its entirety. However, these are merely examples, and any suitable technique(s) for normalizing entity tokens to standard terms may be utilized in some embodiments. In some embodiments, a statistical normalization/coding model may be trained to select the most likely term or code from the list of matching terms/codes based on suitably defined features of the text, such as the entity type, the document type, and/or any other suitable features.

In some embodiments, the normalization/coding process may output a single hypothesis for the standard form and/or code corresponding to each extracted fact. For example, the single output hypothesis may correspond to the concept in the ontology (and/or the corresponding code in a medical code system) linked to the term that is most similar to the token(s) in the text from which the fact is extracted. However, in other embodiments, the normalization/coding process may output multiple alternative hypotheses, e.g., with corresponding probabilities, for the standard form and/or code corresponding to an individual extracted fact. Thus, it should be appreciated that in some embodiments multiple alternative hypotheses for a medical fact to be extracted from a portion of input text may be identified by fact extraction component 104. Such alternative hypotheses may be collected at any or all of various processing levels of fact extraction, including entity detection, entity relation, and/or normalization/coding stages. In some embodiments, the list of alternative hypotheses may be thresholded at any of the various levels, such that the final list output by fact extraction component 104 may represent the N-best alternative hypotheses for a particular medical fact to be extracted.

It should be appreciated that the foregoing are merely examples, and that fact extraction component 104 may be implemented in any suitable way and/or form in some embodiments.

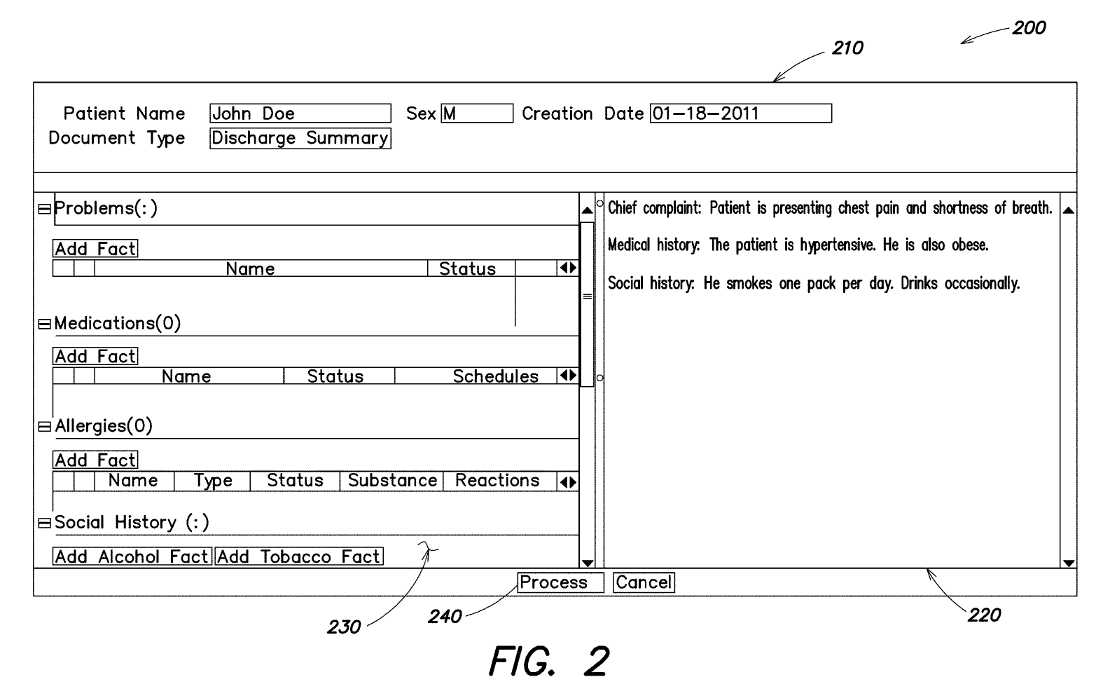

In some embodiments, a user such as clinician 120 may monitor, control and/or otherwise interact with the fact extraction and/or fact review process through a user interface provided in connection with system 100. For example, in some embodiments, user interface 140 may be provided by fact review component 106, e.g., through execution (e.g., by one or more processors of system 100) of programming instructions incorporated in fact review component 106. One exemplary implementation of such a user interface is graphical user interface (GUI) 200, illustrated in FIG. 2. In some embodiments, when the user is clinician 120, GUI 200 may be presented via user interface 110. In some embodiments, a user may be a person other than a clinician; for example, another person such as coding specialist 150 may be presented with GUI 200 via user interface 140. However, it should be appreciated that “user,” as used herein, refers to an end user of system 100, as opposed to a software and/or hardware developer of any component of system 100.

The user interface is not limited to a graphical user interface, as other ways of providing data from system 100 to users may be used. For example, in some embodiments, audio indicators may be transmitted from system 100 and conveyed to a user. It should be appreciated that any type of user interface may be provided in connection with fact extraction, fact review and/or other related processes, as embodiments are not limited in this respect. While the exemplary embodiments illustrated in FIG. 1 involve data processing at system 100 and data communication between system 100 and user interfaces 110 and/or 140, it should be appreciated that in other embodiments any or all processing components of system 100 may instead be implemented locally at user interface 110 and/or user interface 140, as embodiments are not limited to any particular distribution of local and/or remote processing capabilities.

As depicted in FIG. 2, exemplary GUI 200 includes a number of separate panes displaying different types of data. Identifying information pane 210 includes general information identifying patient 222 as a male patient named John Doe. Such general patient identifying information may be entered by clinician 120, or by other user 150, or may be automatically populated from an electronic medical record for patient 122 (e.g., retrieved from data set 160), or may be obtained from any other suitable source. Identifying information pane 210 also displays the creation date and document type of the report currently being worked on. This information may also be obtained from any suitable source, such as from stored data or by manual entry. When referring herein to entry of data by clinician 120 and/or other user 150, it should be appreciated that any suitable form of data entry may be used, including input via mouse, keyboard, touchscreen, stylus, voice, or any other suitable input form, as embodiments are not limited in this respect.

Exemplary GUI 200 as depicted in FIG. 2 includes a text panel 220 in which a text narrative referring to the encounter between clinician 120 and patient 122 is displayed. In some embodiments, text panel 220 may include text editor functionality, such that clinician 120 may directly enter the text narrative into text panel 220, either during the patient encounter or at some time thereafter. If ASR is used to produce the text narrative from a spoken dictation provided by clinician 120, in some embodiments the text may be displayed in text panel 220 as it is produced by ASR engine 102, either in real time while clinician 120 is dictating, or with a larger processing delay. In other embodiments, the text narrative may be received as stored data from another source, such as from medical transcriptionist 130, and may be displayed in completed form in text panel 220. In some embodiments, the text narrative may then be edited if desired by clinician 120 and/or other user 150 within text panel 220. However, text editing capability is not required, and in some embodiments text panel 220 may simply display the text narrative without providing the ability to edit it.

Exemplary GUI 200 further includes a fact panel 230 in which one or more medical facts, once automatically extracted from the text narrative and/or entered in another suitable way, may be displayed as discrete structured data items. When clinician 120 and/or other user 150 is ready to direct fact extraction component 104 to extract one or more medical facts from the text narrative, in some embodiments he or she may select process button 240 via any suitable selection input method. However, a user indication to begin fact extraction is not limited to a button such as process button 240, as any suitable way to make such an indication may be provided by GUI 200. In some embodiments, no user indication to begin fact extraction may be required, and fact extraction component 104 may begin a fact extraction process as soon as a requisite amount of text (e.g., enough text for fact extraction component 104 to identify one or more clinical facts that can be ascertained therefrom) is entered and/or received. In some embodiments, a user may select process button 240 to cause fact extraction to be performed before the text narrative is complete. For example, clinician 120 may dictate, enter via manual input and/or otherwise provide a part of the text narrative, select process button 240 to have one or more facts extracted from that part of the text narrative, and then continue to provide further part(s) of the text narrative. In another example, clinician 120 may provide all or part of the text narrative, select process button 240 and review the resulting extracted facts, edit the text narrative within text pane 220, and then select process button 240 again to review how the extracted facts may change.

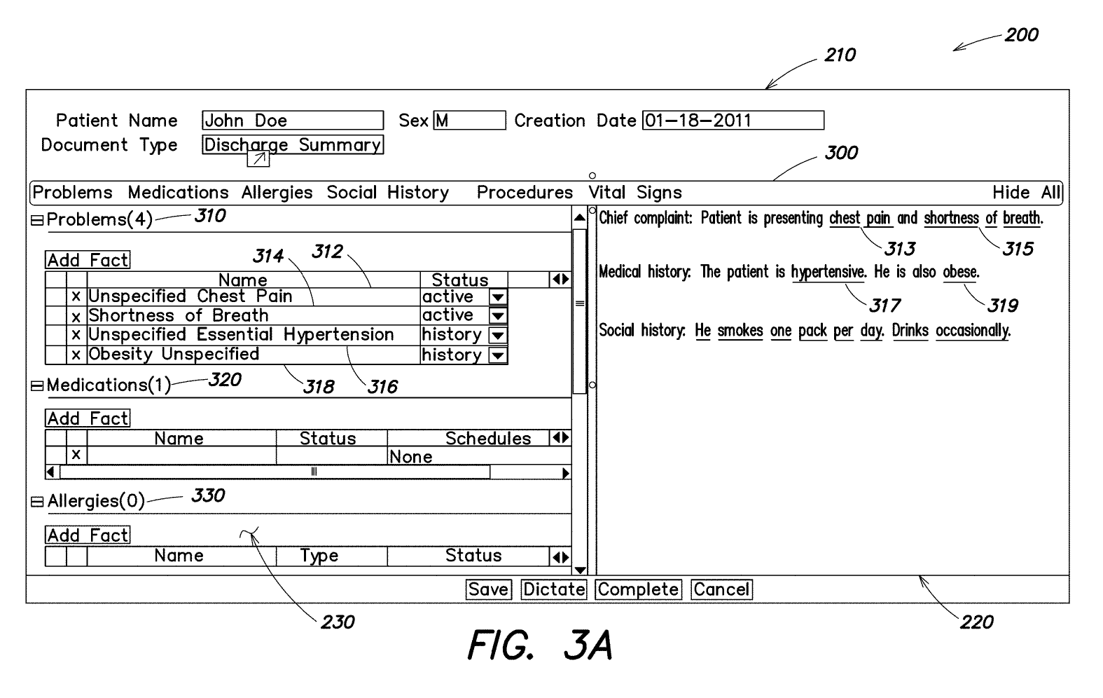

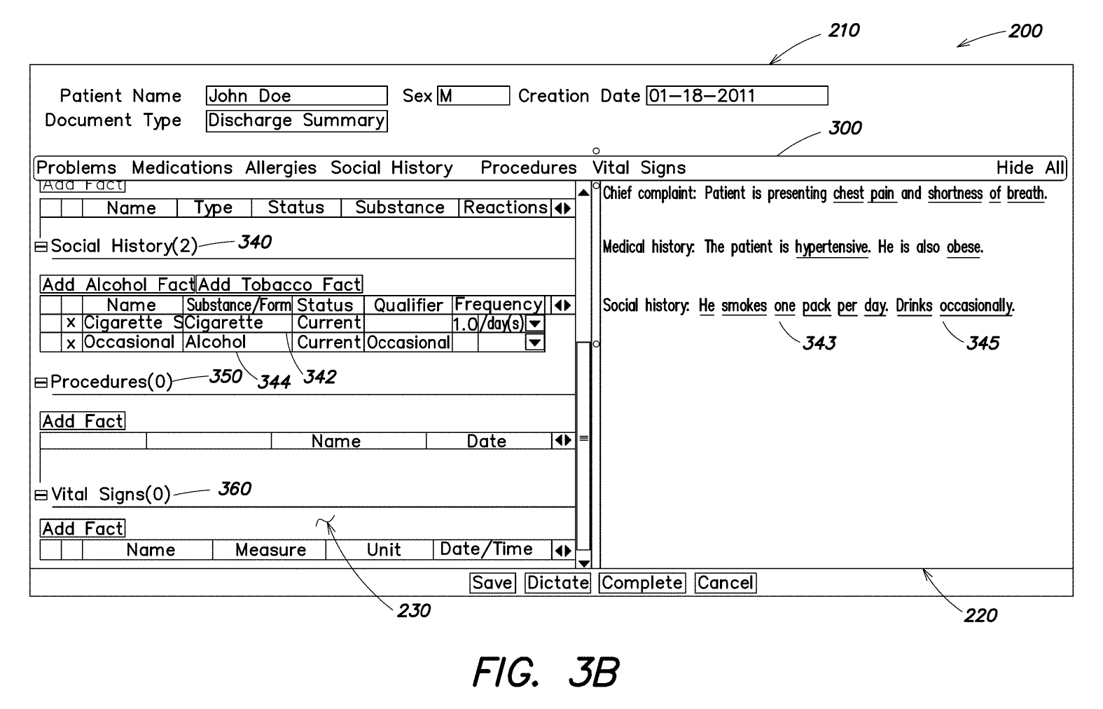

In some embodiments, one or more medical facts extracted from the text narrative by fact extraction component 104 may be displayed to the user via GUI 200 in fact panel 230. Screenshots illustrating an example display of medical facts extracted from an example text narrative are provided in FIGS. 3A and 3B. FIG. 3A is a screenshot with fact panel 230 scrolled to the top of a display listing medical facts extracted from the example text narrative, and FIG. 3B is a screenshot with fact panel 230 scrolled to the bottom of the display listing the extracted medical facts. In some embodiments, as depicted in FIGS. 3A and 3B, medical facts corresponding to a patient encounter may be displayed in fact panel 230, and organized into a number of separate categories of types of facts. An exemplary set of medical fact categories includes categories for problems, medications, allergies, social history, procedures and vital signs. However, it should be appreciated that any suitable fact categories may be used, as embodiments are not limited in this respect. In addition, organization of facts into categories is not required, and displays without such organization are possible. As depicted in FIGS. 3A and 3B, in some embodiments GUI 200 may be configured to provide a navigation panel 300, with a selectable indication of each fact category available in the display of fact panel 230. In some embodiments, when the user selects one of the categories within navigation panel 300 (e.g., by clicking on it with a mouse, touchpad, stylus, or other input device), fact panel 230 may be scrolled to display the corresponding fact category. In the example depicted in FIGS. 3A and 3B, all available fact categories for the current document type are displayed, even if a particular fact category includes no extracted or otherwise entered medical facts. However, this is not required; in some embodiments, only those fact categories having facts ascertained from the patient encounter may be displayed in fact panel 230.

Fact panel 230 scrolled to the top of the display as depicted in FIG. 3A shows problem fact category 310, medications fact category 320, and allergies fact category 330. Within problem fact category 310, four clinical facts have been extracted from the example text narrative; no clinical facts have been extracted in medications fact category 320 or in allergies fact category 330. Within problem fact category 310, fact 312 indicates that patient 122 is currently presenting with unspecified chest pain; that the chest pain is a currently presenting condition is indicated by the status “active”. Fact 314 indicates that patient 122 is currently presenting with shortness of breath. Fact 316 indicates that the patient has a history (status “history”) of unspecified essential hypertension. Fact 318 indicates that the patient has a history of unspecified obesity. As illustrated in FIG. 3A, each clinical fact in problem fact category 310 has a name field and a status field. In some embodiments, each field of a clinical fact may be a structured component of that fact represented as a discrete structured data item. In this example, the name field may be structured such that only a standard set of medical terms for problems may be available to populate that field. For example, the status field may be structured such that only statuses in the Systematized Nomenclature of Medicine (SNOMED) standard (e.g., “active” and “history”) may be selected within that field, although other standards (or no standard) could be employed. An exemplary list of fact categories and their component fields is given below. However, it should be appreciated that this list is provided by way of example only, as aspects of the invention are not limited to any particular organizational system for facts, fact categories and/or fact components.
Exemplary list of fact categories and component fields:
   Category: Problems. Fields: Name, SNOMED status, ICD code.
   Category: Medications. Fields: Name, Status, Dose form, Frequency, Measures, RxNorm code, Administration condition, Application duration, Dose route.
   Category: Allergies. Fields: Allergen name, Type, Status, SNOMED code, Allergic reaction, Allergen RxNorm.
   Category: Social history—Tobacco use. Fields: Name, Substance, Form, Status, Qualifier, Frequency, Duration, Quantity, Unit type, Duration measure, Occurrence, SNOMED code, Norm value, Value.
   Category: Social history—Alcohol use. Fields: Name, Substance, Form, Status, Qualifier, Frequency, Duration, Quantity, Quantifier, Unit type, Duration measure, Occurrence, SNOMED code, Norm value, Value.
   Category: Procedures. Fields: Name, Date, SNOMED code.
   Category: Vital signs. Fields: Name, Measure, Unit, Unit type,
Date/Time, SNOMED code, Norm value, Value.

In some embodiments, a linkage may be maintained between one or more medical facts extracted by fact extraction component 104 and the portion(s) of the text narrative from which they were extracted. As discussed above, such a portion of the text narrative may consist of a single word or may include multiple words, which may be in a contiguous sequence or may be separated from each other by one or more intervening words, sentence boundaries, section boundaries, or the like. For example, fact 312 indicating that patient 122 is currently presenting with unspecified chest pain may have been extracted by fact extraction component 104 from the words “chest pain” in the text narrative. The “active” status of extracted fact 312 may have been determined by fact extraction component 104 based on the appearance of the words “chest pain” in the section of the text narrative with the section heading “Chief complaint”. In some embodiments, fact extraction component 104 and/or another processing component may be programmed to maintain (e.g., by storing appropriate data) a linkage between an extracted fact (e.g., fact 312) and the corresponding text portion (e.g., “chest pain”).

In some embodiments, GUI 200 may be configured to provide visual indicators of the linkage between one or more facts displayed in fact panel 230 and the corresponding portion(s) of the text narrative in text panel 220 from which they were extracted. In the example depicted in FIG. 3A, the visual indicators are graphical indicators consisting of lines placed under the appropriate portions of the text narrative in text panel 220. Indicator 313 indicates the linkage between fact 312 and the words “chest pain” in the “Chief complaint” section of the text narrative; indicator 315 indicates the linkage between fact 314 and the words “shortness of breath” in the “Chief complaint” section of the text narrative; indicator 317 indicates the linkage between fact 316 and the word “hypertensive” in the “Medical history” section of the text narrative; and indicator 319 indicates the linkage between fact 318 and the word “obese” in the “Medical history” section of the text narrative. However, these are merely examples of one way in which visual indicators may be provided, as other types of visual indicators may be provided. For example, different or additional types of graphical indicators may be provided, and/or linked text in text panel 220 may be displayed in a distinctive textual style (e.g., font, size, color, formatting, etc.). Aspects of the invention are not limited to any particular type of linkage indicator.

In some embodiments, when the textual representation of the free-form narration provided by clinician 120 has been re-formatted and fact extraction has been performed with reference to the re-formatted version, the original version may nevertheless be displayed in text panel 220, and linkages may be maintained and/or displayed with respect to the original version. For example, in some embodiments, each extracted clinical fact may be extracted by fact extraction component 104 from a corresponding portion of the re-formatted text, but that portion of the re-formatted text may have a corresponding portion of the original text of which it is a formatted version. A linkage may therefore be maintained between that portion of the original text and the extracted fact, despite the fact actually having been extracted from the re-formatted text. In some embodiments, providing an indicator of the linkage between the extracted fact and the original text may allow clinician 120 and/or other user 150 to appreciate how the extracted fact is related to what was actually said in the free-form narration. However, other embodiments may maintain linkages between extracted facts and the re-formatted text, as an alternative or in addition to the linkages between the extracted facts and the original text, as aspects of the invention are not limited in this respect.

Fact panel 230 scrolled to the bottom of the display as depicted in FIG. 3B shows social history fact category 340, procedures fact category 350, and vital signs fact category 360. Within social history fact category 340, two clinical facts have been extracted; no facts have been extracted in procedures fact category 350 and vital signs fact category 360. Within social history fact category 340, fact 342 indicates that patient 122 currently smokes cigarettes with a frequency of one pack per day. Fact 344 indicates that patient 122 currently occasionally drinks alcohol. Indicator 343 indicates that fact 342 was extracted from the words “He smokes one pack per day” in the “Social history” section of the text narrative; and indicator 345 indicates that fact 344 was extracted from the words “Drinks occasionally” in the “Social history” section of the text narrative. In some embodiments, visual indicators such as indicators 343 and 345 may be of a different textual and/or graphical style or of a different indicator type than visual indicators such as indicators 313, 315, 317 and 319, to indicate that they correspond to a different fact category. For example, in some embodiments indicators 343 and 345 corresponding to social history fact category 340 may be displayed in a different color than indicators 313, 315, 317 and 319 corresponding to problems fact category 310. In some embodiments, linkages for different individual facts may be displayed in different textual and/or graphical styles or indicator types to allow the user to easily appreciate which fact corresponds to which portion of the text narrative. For example, in some embodiments indicator 343 may be displayed in a different color than indicator 345 because they correspond to different facts, even though both correspond to the same fact category.

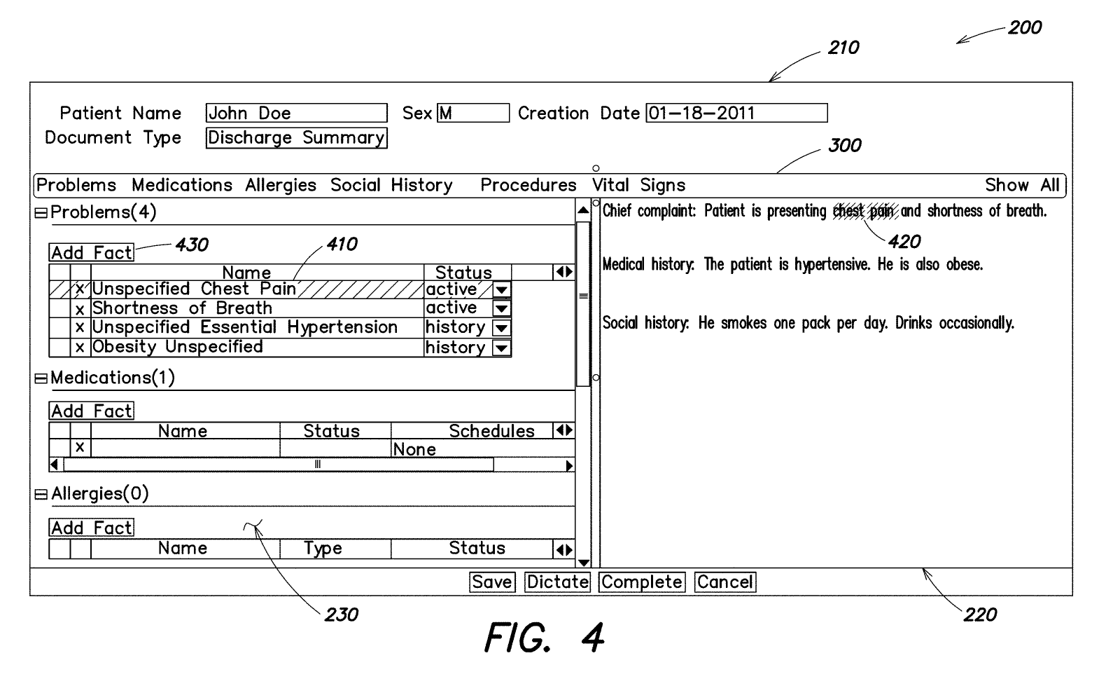

In some embodiments, GUI 200 may be configured to allow the user to select one or more of the medical facts in fact panel 230, and in response to the selection, may provide an indication of the portion(s) of the text narrative from which those fact(s) were extracted. An example is illustrated in FIG. 4. In this example, fact 312 (“unspecified chest pain”) has been selected by the user in fact panel 230, and in response visual indicator 420 of the portion of the text narrative from which fact 312 was extracted (“chest pain”) is provided. Such a user selection may be made in any suitable way, as embodiments are not limited in this respect. Examples include using an input device (e.g., mouse, keyboard, touchpad, stylus, etc.) to click on or otherwise select fact 312, hovering the mouse or other input mechanism above or nearby to fact 312, speaking a selection of fact 312 through voice, and/or any other suitable selection method. Similarly, in some embodiments GUI 200 may be configured to visually indicate the corresponding fact in fact panel 230 when the user selects a portion of the text narrative in text panel 220. In some embodiments, a visual indicator may include a line or other graphical connector between a fact and its corresponding portion of the text narrative. Any visual indicator may be provided in any suitable form (examples of which are given above) as embodiments are not limited in this respect. In addition, embodiments are not limited to visual indicators, as other forms of indicators may be provided. For example, in response to a user selection of fact 312, an audio indicator of the text portion “chest pain” may be provided in some embodiments. In some embodiments, the audio indicator may be provided by playing the portion of the audio recording of the clinician's spoken dictation comprising the words “chest pain”. In other embodiments, the audio indicator may be provided by playing an audio version of the words “chest pain” generated using automatic speech synthesis. Any suitable form of indicator or technique for providing indicators may be used, as embodiments are not limited in this respect.

In some embodiments, GUI 200 may be configured to provide any of various ways for the user to make one or more changes to the set of medical facts extracted from the text narrative by fact extraction component 104 and displayed in fact panel 230, and these changes may be collected by fact review component 106 and applied to the documentation of the patient encounter. For example, the user may be allowed to delete a fact from the set in fact panel 230, e.g., by selecting the “X” option appearing next to the fact. In some embodiments, the user may be allowed to edit a fact within fact panel 230. In one example, the user may edit the name field of fact 312 by selecting the fact and typing, speaking or otherwise providing a different name for that fact. As depicted in FIG. 3A and FIG. 4, in some embodiments the user may edit the status field of fact 312 by selecting a different status from the available drop-down menu; other techniques for allowing editing of the status field are also possible. In some embodiments, the user may alternatively or additionally be allowed to edit a fact by interacting with the text narrative in text panel 220. For example, the user may add, delete, or change one or more words in the text narrative, and then the text narrative may be re-processed by fact extraction component 104 to extract an updated set of medical facts. In some embodiments, the user may be allowed to select only a part of the text narrative in text panel 220 (e.g., by highlighting it), and have fact extraction component 104 re-extract facts only from that part, without disturbing facts already extracted from other parts of the text narrative.

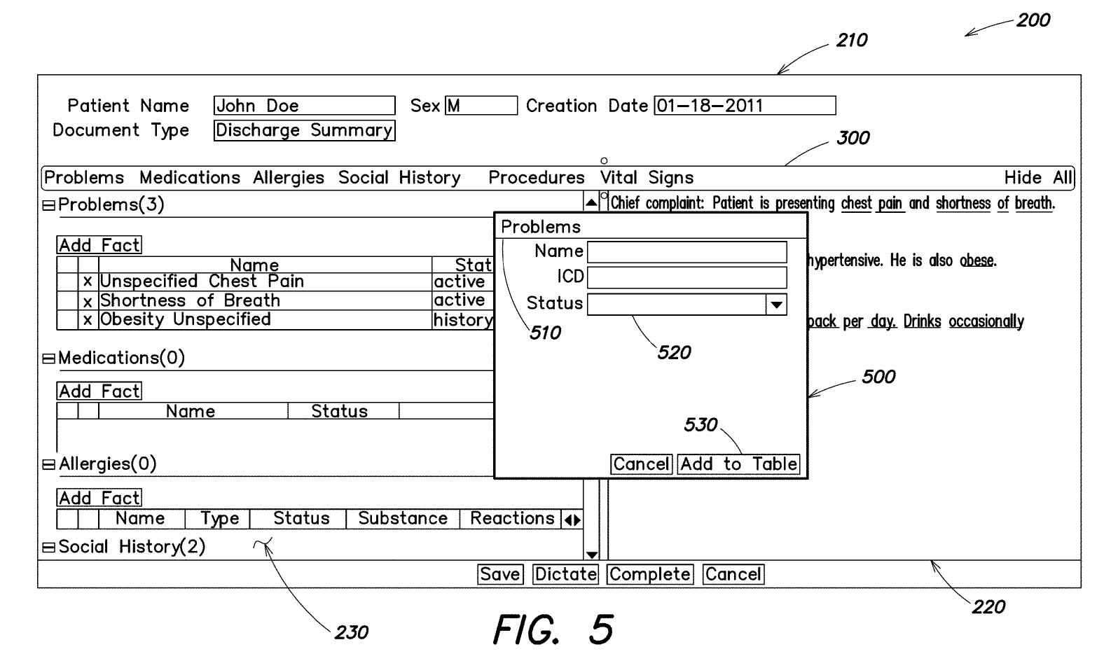

In some embodiments, GUI 200 may be configured to provide any of various ways for one or more facts to be added as discrete structured data items. As depicted in FIG. 4, GUI 200 in some embodiments may be configured to provide an add fact button for each fact category appearing in fact panel 230; one such add fact button is add fact button 430. When the user selects add fact button 430, in some embodiments GUI 200 may provide the user with a way to enter information sufficient to populate one or more fields of a new fact in that fact category, for example by displaying pop-up window 500 as depicted in FIG. 5. It should be appreciated that this is merely one example, as embodiments are not limited to the use of pop-up windows or any other particular method for adding a fact. In this example, pop-up window 500 includes a title bar 510 that indicates the fact category (“Problems”) to which the new fact will be added. Pop-up window 500 also provides a number of fields 520 in which the user may enter information to define the new fact to be added. Fields 520 may be implemented in any suitable form, including as text entry boxes, drop-down menus, radio buttons and/or checkboxes, as embodiments are not limited to any particular way of receiving input defining a fact. Finally, pop-up window 500 includes add button 530, which the user may select to add the newly defined fact to the set of facts corresponding to the patient encounter, thus entering the fact as a discrete structured data item.

In some embodiments, GUI 200 may alternatively or additionally be configured to allow the user to add a new fact by selecting a (not necessarily contiguous) portion of the text narrative in text panel 220, and indicating that a new fact should be added based on that portion of the text narrative. This may be done in any suitable way. In one example, the user may highlight the desired portion of the text narrative in text panel 220, and right-click on it with a mouse (or perform another suitable input operation), which may cause the designated text to be processed and any relevant facts to be extracted. In other embodiments, the right-click or other input operation may cause a menu to appear. In some embodiments the menu may include options to add the new fact under any of the available fact categories, and the user may select one of the options to indicate which fact category will correspond to the new fact. In some embodiments, an input screen such as pop-up window 500 may then be provided, and the name field may be populated with the words selected by the user from the text narrative. The user may then have the option to further define the fact through one or more of the other available fields, and to add the fact to the set of medical facts for the patient encounter as described above.

In some embodiments, the set of medical facts corresponding to the current patient encounter (each of which may have been extracted from the text narrative or provided by the user as a discrete structured data item) may be added to an existing electronic medical record (such as an EHR) for patient 122, or may be used in generating a new electronic medical record for patient 122. In some embodiments, clinician 120 and/or other user 150 may finally approve the set of medical facts before they are included in any patient record; however, embodiments are not limited in this respect. In some embodiments, when there is a linkage between a fact in the set and a portion of the text narrative, the linkage may be maintained when the fact is included in the electronic medical record. In some embodiments, this linkage may be made viewable by simultaneously displaying the fact within the electronic medical record and the text narrative (or at least the portion of the text narrative from which the fact was extracted), and providing an indication of the linkage in any of the ways described above. Similarly, extracted facts may be included in other types of patient records, and linkages between the facts in the patient records and the portions of text narratives from which they were extracted may be maintained and indicated in any suitable way.

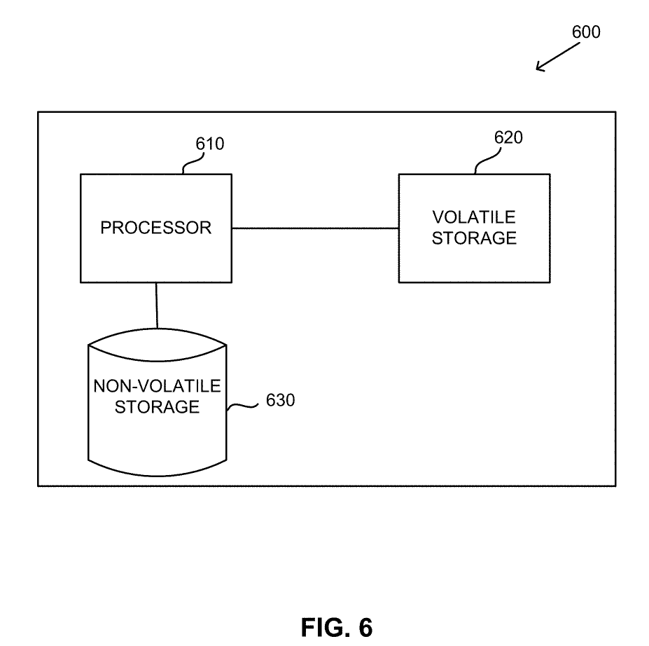

A CLU system in accordance with the techniques described herein may take any suitable form, as aspects of the present invention are not limited in this respect. An illustrative implementation of a computer system 600 that may be used in connection with some embodiments of the present invention is shown in FIG. 6. One or more computer systems such as computer system 600 may be used to implement any of the functionality described above. The computer system 600 may include one or more processors 610 and one or more tangible, non-transitory computer-readable storage media (e.g., volatile storage 620 and one or more non-volatile storage media 630, which may be formed of any suitable non-volatile data storage media). The processor 610 may control writing data to and reading data from the volatile storage 620 and the non-volatile storage device 630 in any suitable manner, as the embodiments are not limited in this respect. To perform any of the functionality described herein, the processor 610 may execute one or more instructions stored in one or more computer-readable storage media (e.g., volatile storage 620), which may serve as tangible, non-transitory computer-readable storage media storing instructions for execution by the processor 610.

Computer-Assisted Coding (CAC) System

As discussed above, medical coding for billing has conventionally been a manual process whereby a human professional (the “coder”) reads all of the documentation for a patient encounter and enters the appropriate standardized codes (e.g., ICD codes, HCPCS codes, etc.) corresponding to the patient's diagnoses, procedures, etc. The coder is often required to understand and interpret the language of the clinical documents in order to identify the relevant diagnoses, etc., and assign them their corresponding codes, as the language used in clinical documentation often varies widely from the standardized descriptions of the applicable codes. For example, the coder might review a hospital report saying, “The patient coded at 5:23 pm.” The coder must then apply the knowledge that “The patient coded” is hospital slang for a diagnosis of “cardiac arrest,” which corresponds to ICD-9-CM code 427.5. This diagnosis could not have been identified from a simple word search for the term “cardiac arrest,” since that standard term was not actually used in the documentation; more complex interpretation is required in this example. When coding in ICD-10, more specificity is required, and the coder may have to read and interpret other parts of the documentation to determine whether the cardiac arrest was due to an underlying cardiac condition (ICD-10-CM code 146.2), or due to a different underlying condition (ICD-10-CM code 146.8), or whether the cause of the cardiac arrest was not mentioned in the documentation (ICD-10-CM code 146.9), which might affect the level of reimbursement for any related services.

As also discussed above, conventional medical coding systems may provide a platform on which the human coder can read the relevant documents for a patient encounter, and an interface via which the human coder can manually input the appropriate codes to assign to the patient encounter. By contrast, some embodiments described herein may make use of a type of medical coding system referred to herein as a “computer-assisted coding” (CAC) system, which may automatically analyze medical documentation for a patient encounter to interpret the document text and derive standardized codes hypothesized to be applicable to the patient encounter. The automatically derived codes may then be suggested to the human coder, clinician, or other user of the CAC system. In some embodiments, the CAC system may make use of an NLU engine to analyze the documentation and derive suggested codes, such as through use of one or more components of a CLU system such as exemplary system 100 described above. In some embodiments, the NLU engine may be configured to derive standardized codes as a type of medical fact extracted from one or more documents for the patient encounter, and/or the CLU system may be configured to access coding rules corresponding to the standardized code set(s) and apply the coding rules to automatically extracted medical facts to derive the corresponding codes.

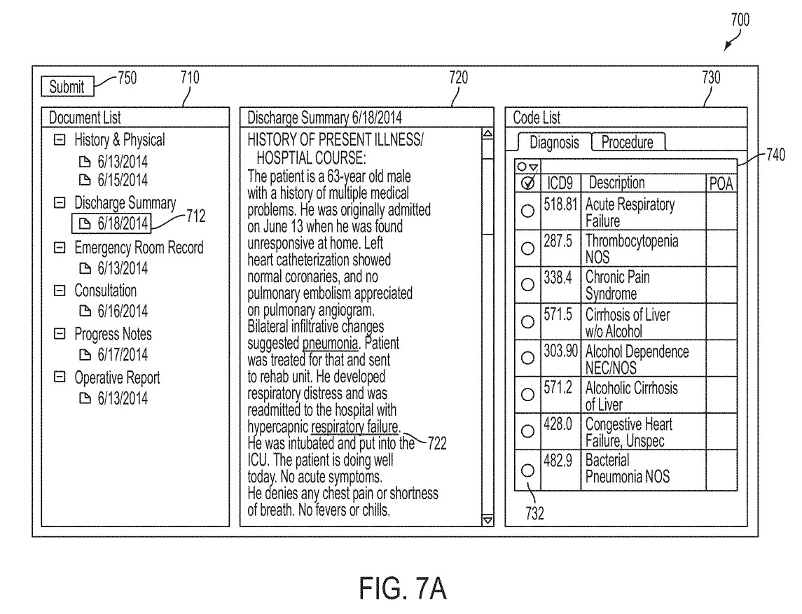

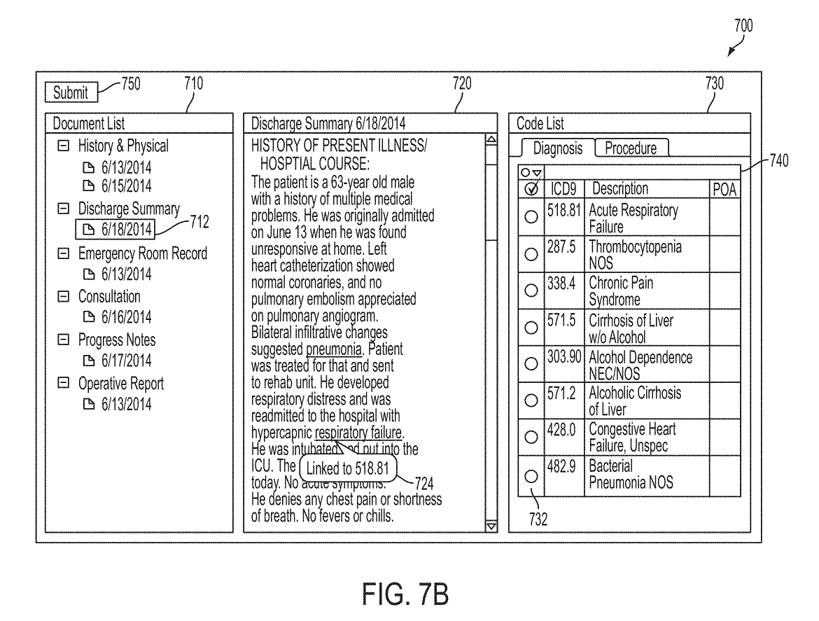

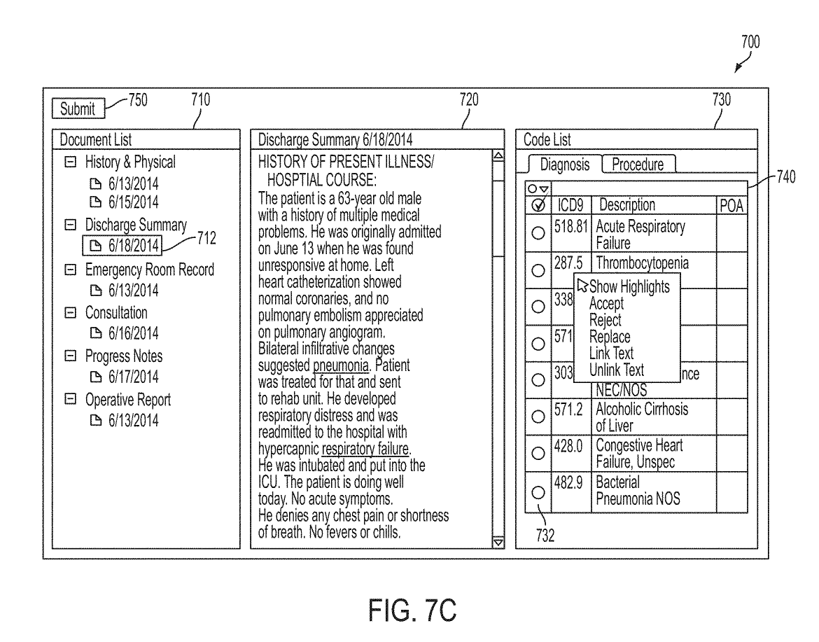

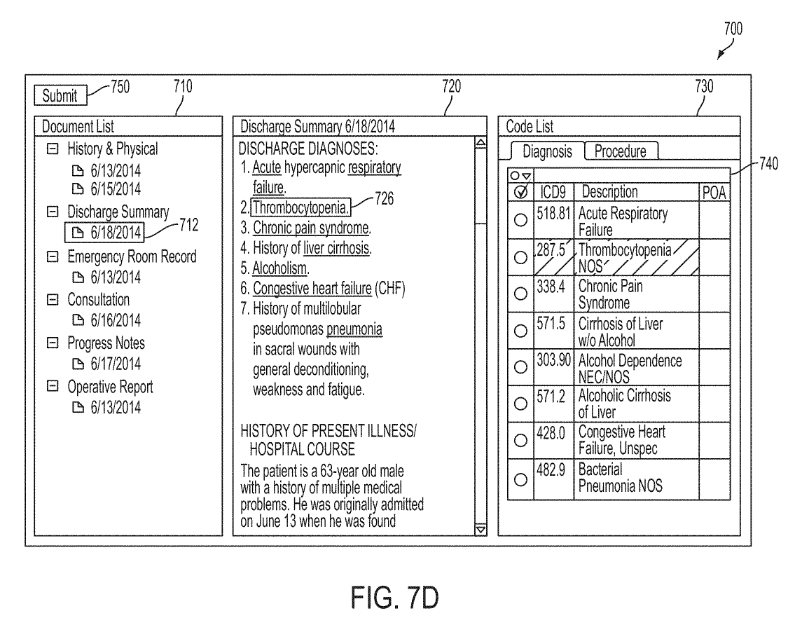

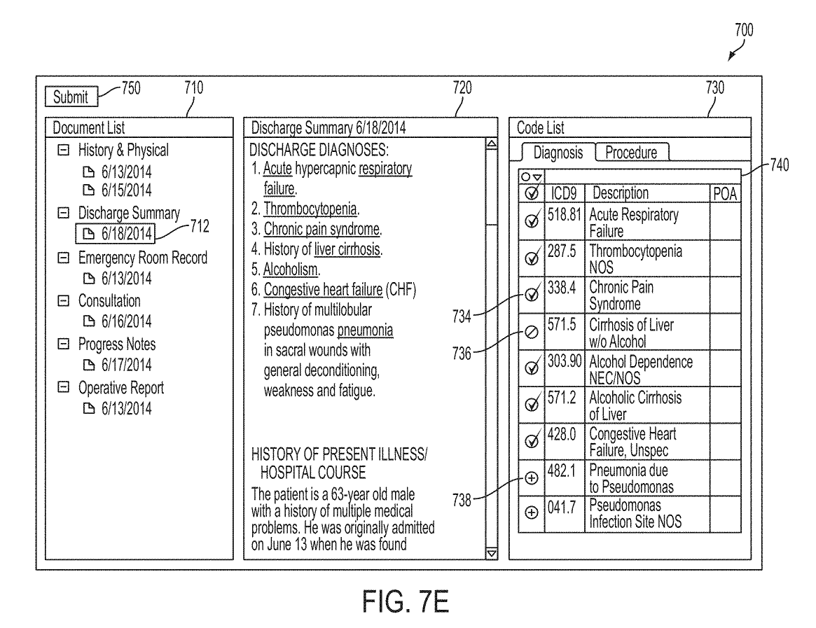

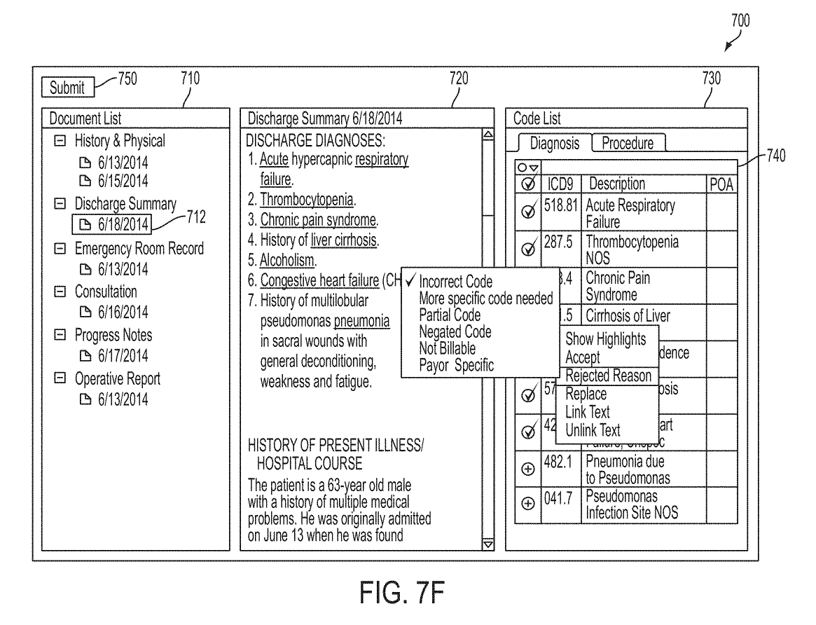

In some embodiments, the CAC system may be configured to provide a user interface via which the automatically suggested codes may be reviewed by a user such as a medical coder. For example, in some embodiments, a CAC system may be utilized in an operating environment similar to that shown in FIG. 1, in which the NLU engine may operate as part of fact extraction component 104, and a review/coding component may operate in place of or concurrently with fact review component 106. The user interface provided by the CAC system may take on any of numerous forms, and some embodiments are not limited to any particular implementation. Like the user interfaces for the CLU system 100 described above, the user interface for the CAC system may provide tools that allow a coder to interact with the CAC system in any suitable form, including visual forms, audio forms, combined forms, or any other form providing the functionality described herein. When the tools are provided in visual form, their functionality may be accessed in some embodiments through a graphical user interface (GUI), which may be implemented in any suitable way in some embodiments and presented via one or more display devices. An example of a suitable GUI 700 for a CAC system is illustrated in FIG. 7A.

The exemplary GUI 700 provides the user with the ability to simultaneously view the list of codes for a patient encounter along with the documentation from which the NLU engine-suggested codes are derived. Some embodiments may also allow the user to view structured encounter- or patient-level data such as the patient's age, gender, etc. (not shown in FIG. 7A), some or all of which information may be useful in arriving at the appropriate codes for the patient encounter. In panel 710 is displayed a list of available documents for the patient encounter currently being coded. In the example illustrated in FIG. 7A, these include two History & Physical reports, a Discharge Summary, an Emergency Room Record, a Consultation report, a Progress Note, and an Operative Report. Indicator 712 shows that the current document being viewed is the Discharge Summary dated Jun. 18, 2014, and this document appears in panel 720 where the user can view the text of the document. Shown in panel 730 is the current list of codes being considered for the patient encounter. An indicator 732 shows, for each code in the list, whether the code was automatically suggested by the NLU engine, added manually by the user, or potentially received from another source. In this particular example, the empty circles indicate that all of the codes in the current list are engine-suggested codes that were automatically suggested by the CAC system.

Exemplary GUI 700 also provides the user with the ability to view and/or query which portion(s) of the available documentation gave rise to the suggestion of which code(s) in the list of codes for the patient encounter. In some embodiments, any suitable indicator(s) may be provided of the link between a particular code and the portion(s) of the documentation text from which the code was derived. Each automatically suggested code may be linked to one or more portions of text from which the code was derived, and each linked portion of text may be linked to one or more codes that are derivable from that portion of text. For instance, viewing together FIGS. 7A and 7D, which show the Discharge Summary viewed at different scroll locations in panel 720, it can be seen that there are two different mentions of “respiratory failure” in the document from which code 518.81 may have been derived (an example of a link between a code and multiple portions of text), and that there are two different codes 303.90 and 571.5 that may have been derived at least in part from the mention of “Alcoholism” in the text (an example of a link between a portion of text and multiple codes).

In the example of FIG. 7A, an indicator 722 is provided (underlining in this particular example) to visually distinguish portions of the document text linked to codes in the current list. Exemplary GUI 700 also allows the user to query a particular linked portion of text to see which code(s) are linked to that portion of text. FIG. 7B illustrates an exemplary indicator 724 of the corresponding link that may be displayed in response to the user querying the linked portion of text in any suitable way, such as by selecting or hovering over it with the mouse pointer. Exemplary GUI 700 further allows the user to query a particular code to see which portion(s) of text are linked to that code. FIG. 7C illustrates an exemplary way of querying code 287.5 by right-clicking on the listed code in panel 730 and selecting “Show Highlights” in the context menu that then appears. In response, the document in which the linked text appears is displayed in panel 720 (in this case it is the same Discharge Summary, scrolled to a particular section), and the linked text is visually distinguished by indicator 726 (highlighting in this particular example), as illustrated in FIG. 7D.

If the user disagrees with the linked text and does not believe that the suggested portion(s) of text actually should correspond with the linked code, the user can select “Unlink Text” in the context menu of FIG. 7C to cause the link between that code and the corresponding text to be discarded. The user can also manually create a new link between a code and one or more portions of text, e.g., by selecting “Link Text” in the context menu of FIG. 7C and highlighting or otherwise designating the portion(s) of text in the documentation which should be linked to the selected code. In some embodiments, when the user performs an action of this type, the action may be fed back as training to the NLU engine to improve its future associations of particular narrative text portions to particular billing codes.

Exemplary GUI 700 further allows the user to accept or reject each of the automatically suggested codes, e.g., using the context menu of FIG. 7C for each suggested code. FIG. 7E illustrates exemplary indicators 734 and 736 which replace indicator 732 for each code that has been accepted or rejected, respectively. In this example, the user has accepted most of the suggested codes (making those accepted codes into user-approved codes), but has rejected code 571.5 because the user believes the mention of “Alcoholism” in the documentation makes the diagnosis of “Cirrhosis of Liver w/o Alcohol” incorrect. Exemplary GUI 700 further allows the user to provide a reason for the rejection of a code, such as by using the exemplary context menu illustrated in FIG. 7F. In some embodiments, the reasons provided by users for rejecting particular automatically suggested codes may be used for review and/or training purposes (e.g., for training the NLU engine, e.g., of the CLU system to derive more accurate codes from documentation text).

GUI 700 may also allow the user to replace a code with a different code, instead of rejecting the code outright, e.g., using the context menu of FIG. 7C. In the example illustrated in FIG. 7E, the user has replaced code 482.9 with code 482.1, and indicator 738 shows that the new code was user-added. 482.9 (Pneumonia due to Pseudomonas) is a more specific diagnosis applicable to the patient encounter than the suggested 482.1 (Bacterial Pneumonia, Unspecified), so the user may provide “More specific code needed” as the reason for the replacement. In some embodiments, when a user replaces an automatically suggested code with a different code, any documentation text that was linked to the originally suggested code may then be linked to the replacement code. Such replacement codes, optionally with linked text and/or replacement reasons, may also be used as feedback, e.g., for training of the CLU system. In some embodiments, identifier data may be associated with the replacement code to indicate that the code is a user-added replacement for an engine-suggested code, and data indicating the original engine-suggested code may also be tracked, to distinguish this code from other codes that may be user-added not as replacements for any engine-suggested codes. This identifier data may be maintained in association with the replacement code, to be used in determining how the replacement code, the engine-suggested code it replaced, and the linked document text will be used as feedback and further training for the NLU engine. Alternatively or additionally, in some embodiments the identifier data may be used to provide a symbol or other status indicator in association with the replacement code in the GUI 700 (not shown in FIG. 7E), letting the user know that this code 482.1 is a replacement code for an engine-suggested code, as opposed to a purely user-added code.

In some embodiments, when the user performs actions (i.e., enters user input) via the GUI to modify the currently presented set of engine-suggested medical billing codes for the patient encounter (e.g., in any of the ways described above), the user's modification of the engine-suggested codes may be used as feedback for adjusting the NLU engine. For example, the user modification of the presented set of engine-suggested codes may include rejecting an engine-suggested code and/or replacing an engine-suggested code with a different code. In this case, the action may be used as feedback to adjust the NLU engine to not suggest that code or similar codes in similar circumstances (e.g., from similar documentation text) going forward. In another example, the user modification may include rejecting and/or replacing a portion of the documentation text that the NLU engine linked to an engine-suggested code for the patient encounter. This user action may indicate that the linked text portion actually does not provide good evidence for the engine-suggested code being applicable to the patient encounter, and this may be used as feedback to adjust the NLU engine not to link similar text to that code or similar codes going forward. In another example, the user modification may include accepting (i.e., approving) an engine-suggested code, which may modify the engine-suggested code by changing its status from merely engine-suggested to user-approved. In this case, the action may be used as feedback to adjust the NLU engine to increase its propensity to suggest that code or similar codes in similar circumstances going forward, or to increase its confidence level in doing so, etc.

In some embodiments, feedback to the NLU engine based on user coding/review actions performed via the CAC GUI may occur during the coding of the patient encounter, as opposed to only after the coding is complete. For example, in some embodiments, the user modification to the current set of codes for the patient encounter that is used as feedback to adjust the NLU engine may result in a modified, unfinalized set of user-approved billing codes for the patient encounter. The set of codes at this point may be unfinalized because the user still has further codes to review, has further documents to review for the patient encounter, has not yet decided on the final sequence of the codes or the principal diagnosis, or simply is not ready yet to finalize the coding of the patient encounter for any suitable reason, etc. In some embodiments, feedback based on the user's actions in the CAC workspace may be used to adjust the NLU engine immediately after the actions are performed, even though the code set for the encounter is still unfinalized. In another example, the feedback may be provided to adjust the NLU engine when the user saves the current code set (in its unfinalized state), e.g., in order to take a break and return to the task of coding the patient encounter later.

In each of these examples, since the feedback based on the user's actions via the GUI may be used to adjust the NLU engine while the set of user-approved medical billing codes for the patient encounter is still unfinalized, in some embodiments the adjusted NLU engine may then be applied to automatically derive a new set of engine-suggested billing codes from the documentation of the encounter, and the new set of engine-suggested codes may be different from the previous set. For example, if the user rejected a particular code from the first set of engine-suggested codes, the NLU engine may be adjusted to learn from this and then suppress the suggestion of another same or similar code from a different part of the documentation in the same patient encounter. In another example, if the user replaced a particular code from the first set of engine-suggested codes with a different code (for example, a more specific code), the NLU engine may be adjusted accordingly and the adjusted engine may also change another same or similar code from a different part of the documentation of the same patient encounter to be similarly more specific. In some embodiments, when the new set of codes has been suggested by the adjusted NLU engine for the patient encounter from which the user modification feedback was received, the new set of codes may be presented for user review and consideration in the GUI before the coding of the patient encounter is finalized.

Any suitable technique(s) may be utilized to adjust the NLU engine based on the feedback from the coding/review process. Exemplary techniques for NLU engine adjustment based on user corrections in a CLU system are described in U.S. Pat. No. 8,694,335. The disclosure of that patent is hereby incorporated by reference herein in its entirety.

Exemplary GUI 700 also allows a user to add a code to the list for a patient encounter, independent of any of the engine-suggested codes, by manually inputting the user-added code in input field 740 of exemplary GUI 700. For example, FIG. 7E shows a new code 041.7 that has been added by the user. Exemplary GUI 700 also allows the user to link the added code to supporting portion(s) of the text, such as the mention of “pseudomonas” in the Discharge Summary, e.g., by using the “Link Text” procedure described above. This user input via the GUI thus communicates the user's identification of the linked portion of the text as providing evidence for the user-added code as being applicable to the patient encounter. A user may also manually link documentation text as supporting evidence for a replacement code. Alternatively or additionally, in some embodiments in response to receiving a user-added code, the CAC system may apply the NLU engine to automatically identify one or more portions of the documentation text as providing evidence for that code being applicable to the patient encounter. In some embodiments, when a user-added code is received, the CAC system may then automatically derive one or more additional engine-suggested codes that the user-added code makes applicable to the patient encounter, and may present those additional codes for user review. For example, the CAC system may have access to a set of coding rules for the standard code system that is being used (e.g., ICD, CPT, etc.), and those may include rules that trigger additional codes when base certain codes are entered (e.g., “code first” rules, “code also” rules, “use additional code” rules, etc.). In another example, a user-added code may cause the CAC system to suppress suggesting one or more other engine-suggested codes that are made inapplicable by the user-added code (e.g., because of an “excludes” rule associated with the user-added code).

Each of the foregoing is an example of a type of back-and-forth interaction between manual coding and automated NLU code suggestion and documentation that the inventors have appreciated may be made possible in an integrated application for both manual coding and user review of engine-suggested codes for a patient encounter. As illustrated in the example of FIG. 7E, in some embodiments the unified workspace of such an integrated CAC application may present both engine-suggested billing codes and user-added billing codes for a patient encounter in the same window in the GUI. In some embodiments, further, the source/status of each billing code in the workspace may be tracked (e.g., as user-added, engine-suggested, engine-suggested and user-approved, engine-suggested and user-rejected, received from an external source, etc.), and appropriate status indicators may be provided in the GUI (e.g., indicators 734, 736, 738). In some embodiments, some billing codes may be derived cooperatively by the NLU engine and the human coder. For example, in a case where the NLU engine is unable to arrive at a fully specified billing code (e.g., a final seven-character ICD-10 code), in some embodiments the NLU engine may suggest the first few digits of the code that it is able to determine automatically from the documentation text, and the coder may then complete the code manually via the GUI. In some embodiments, manual completion of an engine-suggested partial code may cause the status of the code to be changed from “engine-suggested” to “user-added,” while the links to documentation evidence for the code as suggested by the NLU engine may be retained. In some embodiments, when the coder manually completes a code that the NLU engine suggested a partial version of, the coder may also have the opportunity to manually link one or more portions of the documentation text to the completed code as evidence, and/or the NLU engine may be applied to automatically identify one or more portions of the documentation text providing evidence for the manually completed code.

Similar to user actions on engine-suggested codes via the CAC GUI, in some embodiments, alternatively or additionally, user actions directed to user-added codes may be provided as learning feedback to the NLU engine during the coding of the patient encounter. For example, an initial set of engine-suggested codes for the patient encounter may be modified by the user by entering a user-added code into the current code set for the encounter. A further modification may be identification by the user of a portion of the documentation text as providing evidence for the user-added code as being applicable to the patient encounter. In some embodiments, such user actions may be used as feedback to adjust the NLU engine using any of the techniques discussed above, e.g., to make the NLU engine more likely to suggest the same or similar codes and/or evidence going forward, including in subsequently suggesting new codes for the same patient encounter and coding process. In some embodiments, adjusting the NLU engine may include training the NLU engine to automatically identify evidence in documentation text (i.e., one or more particular text portions) for the user-added code as being applicable to the patient encounter.

In some embodiments, there may be situations in which the user has already approved one or more codes for a patient encounter (e.g., by accepting one or more automatically-suggested codes with or without modification, or by manually inputting one or more codes) when the NLU engine (e.g., as part of the CLU system) derives one or more new codes for the same encounter. For instance, in one example, a new document may become available in document list 710 for a patient encounter after the coder has already been working on coding the encounter, and the NLU engine may be used to analyze the new document and derive one or more codes from it. In some embodiments, the new engine-derived codes may be compared with the previously user-approved codes to determine whether any of the new engine-derived codes should be filtered from presentation in code list 730. In some embodiments, an engine-derived code may be filtered from presentation when it is identified as overlapping with a user-approved code, in which case the engine-derived code need not be presented separately from the user-approved code in code list 730.

Medical billing codes may be identified as overlapping in any suitable way. In one example, an engine-derived diagnosis code may be identified as overlapping if it is the same code as a user-approved diagnosis code. In another example, an engine-derived procedure code may be identified as overlapping if it is the same code as a user-approved procedure code. However, in some embodiments, when a new engine-derived procedure code is the same code as a previously user-approved procedure code, a determination may be made, before filtering the engine-derived procedure code, as to whether the patient actually underwent the same procedure twice, and the new engine-derived code is for a different occurrence of the procedure than the previously user-approved code. In some embodiments, such a determination may be made automatically from the facts extracted from the documentation using the NLU engine. If the patient did undergo the same procedure twice, then in some embodiments both the user-approved procedure code and the engine-derived procedure code may be presented in code list 730, with separate links to corresponding textual documentation. If it is determined that the patient did not undergo the same procedure twice, then in some embodiments the new engine-derived procedure code may not be presented in code list 730 separately from the user-approved procedure code, since they refer to the same procedure that was performed only once on the patient.

In another example, an engine-derived code may be identified as overlapping with a user-approved code when the engine-derived code is a less specific version of the user-approved code. An example may be if the NLU engine derives a code for a bone fracture when the user has already approved a code for the same bone fracture plus dislocation. In some embodiments, the more specific user-approved code may be retained instead of the less specific engine-derived code, and the engine-derived code may not be presented in code list 730. In some embodiments, when a new engine-derived code is more specific than a previously user-approved code, then both codes may be presented in code list 730 for the user's review. In some embodiments, an alert may be provided to the user, indicating that a more specific code is available for consideration to replace the user-approved code.

In some embodiments, when an engine-derived code is determined to overlap with a user-approved code, the text linked to the engine-derived code (e.g., from the new document from which the engine-derived code was derived) may be linked to the user-approved code, e.g., by generating a new link between the user-approved code and the portion of text in the new document from which the engine-derived code was derived. In some such embodiments, when the user then selects the user-approved code (e.g., via the “Show Highlights” option in the context menu of FIG. 7C) in code list 730, an indicator of the newly linked text (corresponding to the engine-derived code) may be provided in document panel 720, e.g., by highlighting the text. In some embodiments, an alert may be provided to the user, indicating that additional documentation evidence (in the form of additional linked text) is now available in support of the user-approved code. In some embodiments, this may provide the user with further information to consider before finalizing the code set, and/or may provide enhanced documentation for later quality review and/or training purposes. In some embodiments, an alert may similarly be provided to the user when the NLU engine identifies new linked text in support of a previously user-rejected code.

In some embodiments, suggestion of a new engine-derived code may likewise be suppressed if the new engine-derived code is determined to overlap with a code that the user has already rejected or replaced while working on coding the patient encounter. In some embodiments, when a new engine-derived code overlaps with a previously rejected or replaced code, the new engine-derived code and its supporting documentation text may not be presented to the user, and may simply be discarded or may be retained in a data set and marked for suppression from the user interface. In other embodiments, however, the user may be provided with an alert that a new engine-derived code overlapping with a previously rejected or replaced code is available. The alert may provide the user with an opportunity to review the new engine-derived code and/or its supporting evidence, e.g., in case the new evidence might change the user's mind about the code and convince the user to accept the code as a user-approved billing code for the patient encounter. Similarly, in some embodiments, an alert may be provided when a document from the patient encounter is deleted or updated in a way that removes text that had been linked to a user-approved code for the patient encounter, so that the user may reconsider whether the code should still be approved given that some of its supporting evidence in the documentation has been deleted or changed.

In some embodiments, the CAC application and exemplary GUI 700 may additionally receive, track, and present one or more billing codes for a patient encounter that have been added external to the CAC GUI (i.e., outside of the CAC system). For example, such billing codes may have been added to the patient encounter directly through the patient's EHR or from any other suitable source (e.g., charge master codes, revenue codes, etc.). In some embodiments, these codes may be treated by the CAC system as user-added or user-approved codes, or as otherwise approved codes for the patient encounter. In some embodiments, in response to receiving such an externally added code, the CAC system may automatically determine whether the externally added code is a duplicate of an engine-suggested code in the patient encounter, e.g., by determining whether the externally added code overlaps with any engine-suggested code in any of the ways described above. In some embodiments, when it is determined that an externally added code is a duplicate of an engine-suggested code that has linked documentation text as supporting evidence, that portion of the documentation text may then be linked as well to the matching externally added code, and the engine-suggested code may be merged with the externally added code as a single user-approved code. In some embodiments, when an externally added code is not a duplicate and is not merged with any engine-suggested code, the externally added code may be treated as a user-approved code in the CAC workspace, but may be flagged so that it is not fed back to the NLU engine for adaptation/learning, since the externally added code may have been applied from another source and may not have any derivable evidentiary relationship with the documentation available to the NLU engine for the patient encounter. However, in some embodiments, externally added codes may trigger suggestion of additional engine-suggestion codes and/or suppression of suggestion of some engine-suggested codes based on coding rules (e.g., “code first,” “code also,” “use additional code,” “excludes” rules, etc.). In some embodiments, externally added codes may alternatively or additionally be used by the NLU engine to make other engine-suggested codes more or less likely applicable to the patient encounter (e.g., changing the probabilities by which other codes are automatically derived from the documentation text and suggested).

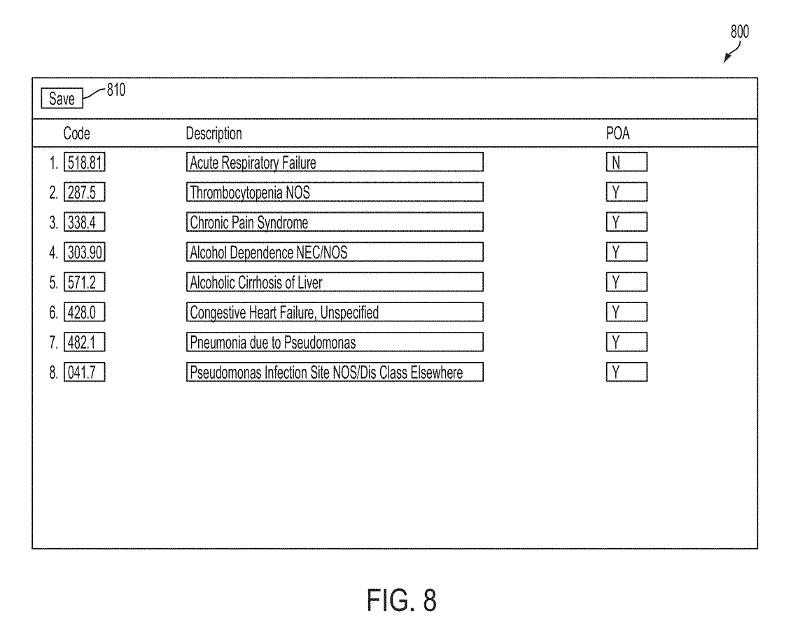

When the user has completed the review of the codes and supporting documentation and is ready to complete the coding of a patient encounter, exemplary GUI 700 allows the user to submit the codes for finalization by selecting button 750. In some embodiments, this may function as a selectable option to send the set of user-approved medical billing codes as a finalized set of medical billing codes for the patient encounter to a billing process. In some embodiments, selection of option 750 may redirect the user out of the coding workspace to a separate screen for finalization. FIG. 8 illustrates an exemplary code finalization screen 800 that may be displayed in some embodiments following the user's selection of submit button 750. In exemplary screen 800, all of the accepted and user-added codes are displayed for final review. Alternatively, in some embodiments the user may be required to affirmatively accept even user-added codes before they will appear in code finalization screen 800. The codes are displayed in screen 800 in an ordered sequence, which the user may change by re-ordering the codes. In some embodiments, the order of the finalized sequence of codes may be used in later processes such as billing, to determine the principal diagnosis, etc. Exemplary screen 800 also includes fields for “present on admission” (POA) indicators, which provide information on whether each diagnosis was present when the patient was admitted to the hospital, or was acquired during the hospital stay. This information may be required documentation in some circumstances, and in some embodiments may be used for review and/or training purposes. In some embodiments, POA indicators may be automatically suggested, e.g., using the CLU system; while in other embodiments, POA indicators may only be input manually.

When the user is satisfied with the finalized sequence of codes, exemplary screen 800 provides a button 810 for the codes to be saved, at which the coding process for the patient encounter becomes complete. In some embodiments, the system may compare the finalized sequence of codes with stored coding rules, and may present the user with any applicable error or warning notifications prior to saving. As discussed above, once saved, the finalized sequence of codes may be sent to other processes such as billing and quality review, and in some embodiments may be used for offline performance review and/or training of the CLU and/or CAC systems.

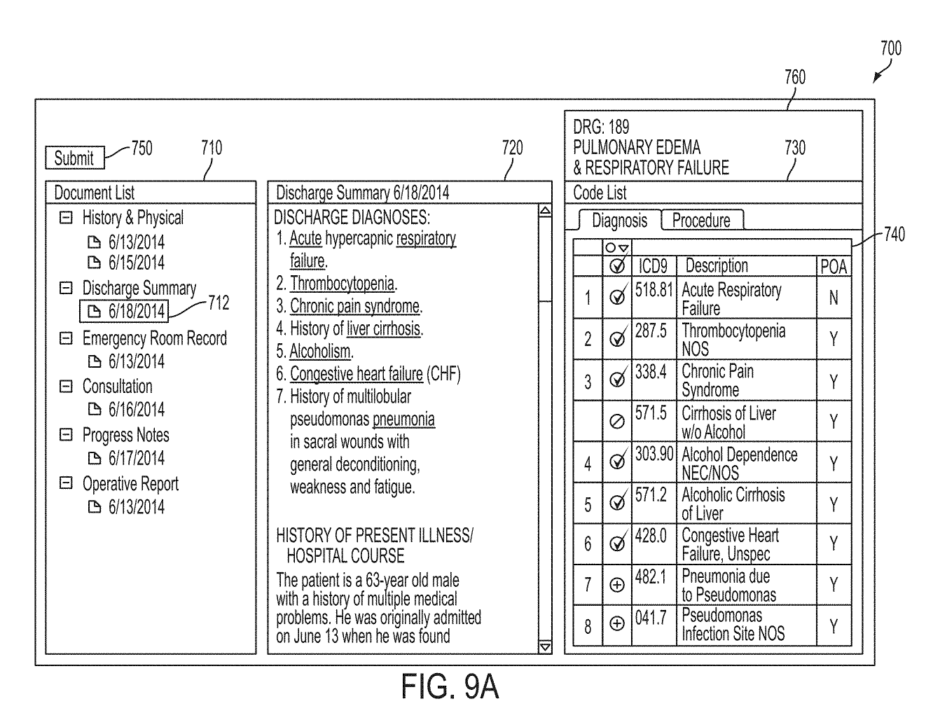

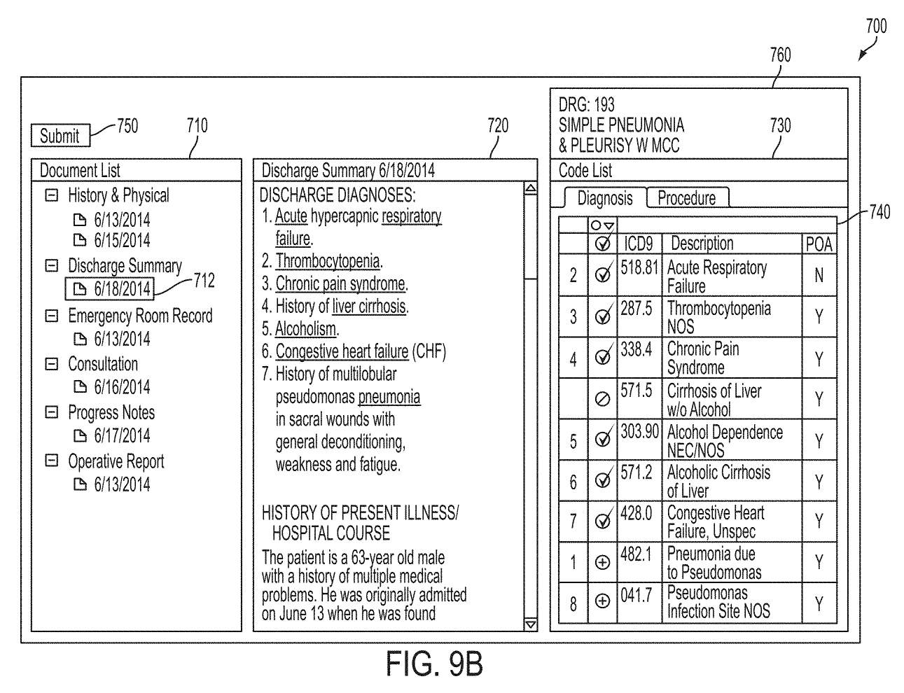

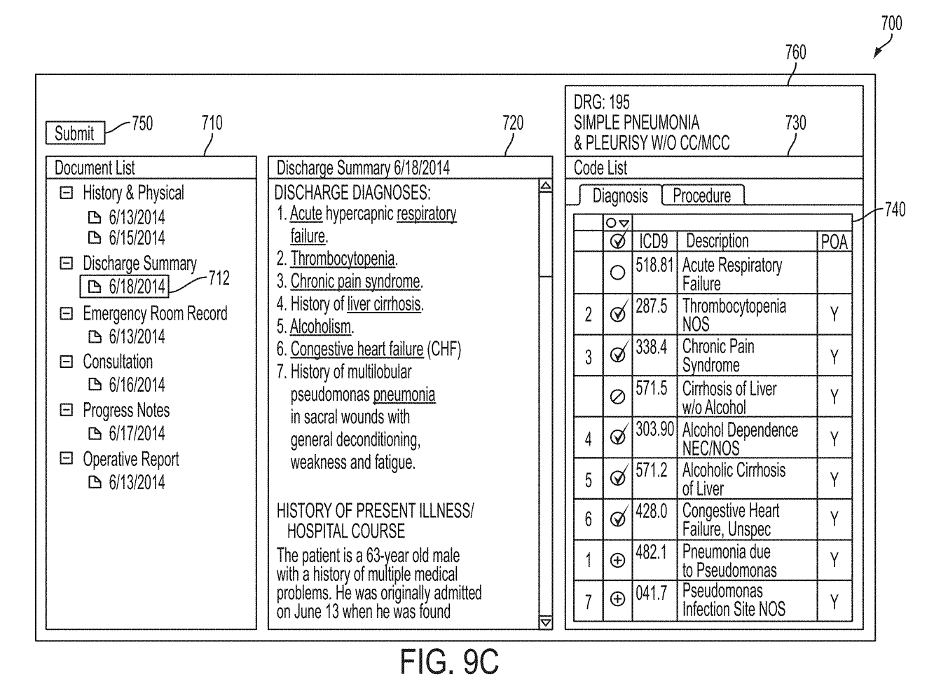

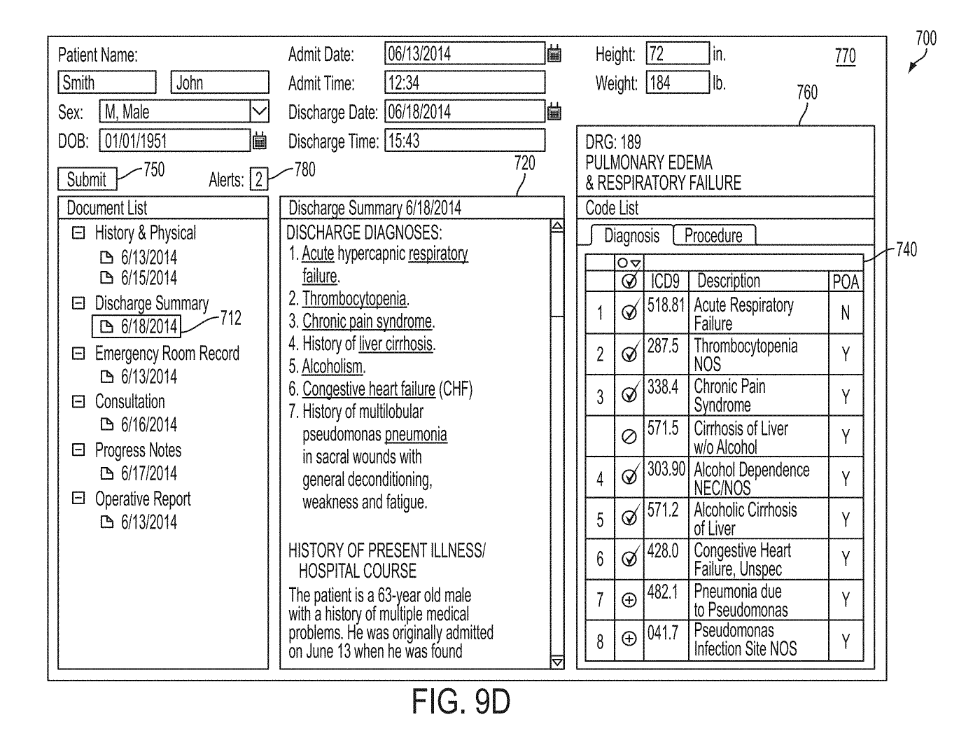

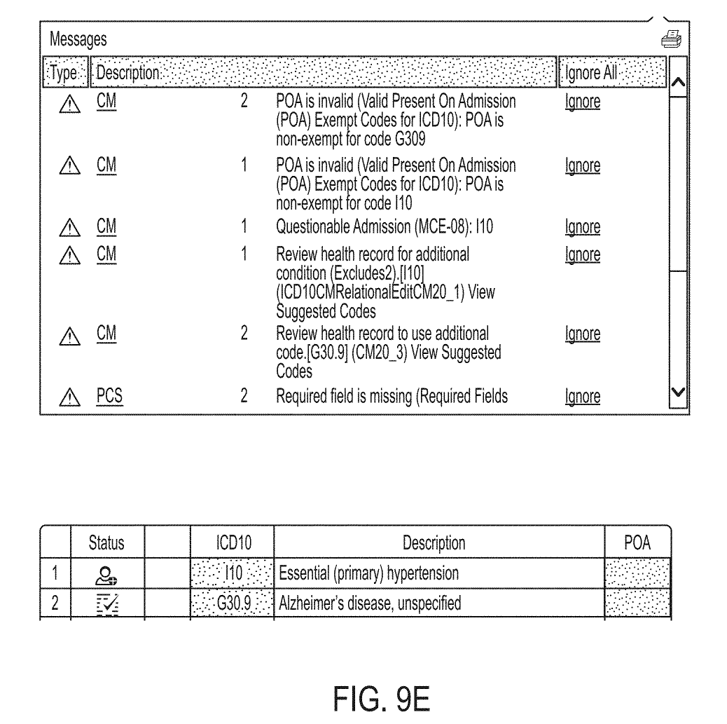

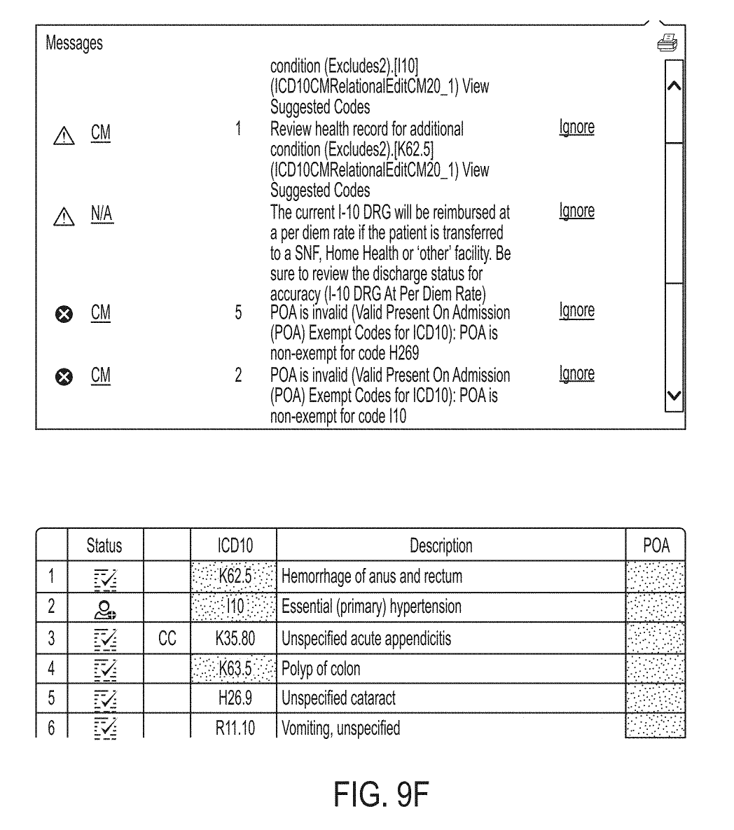

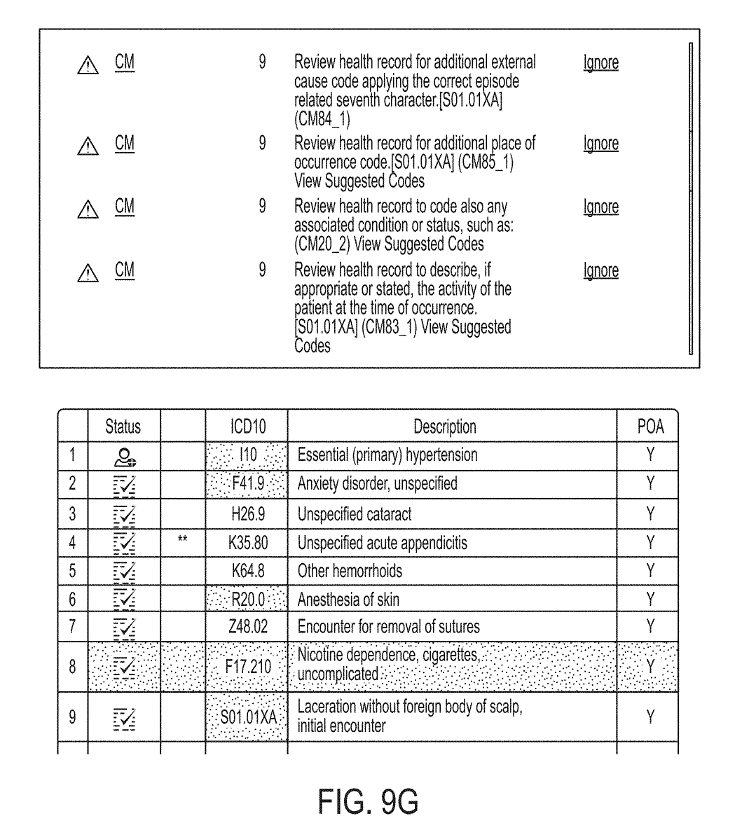

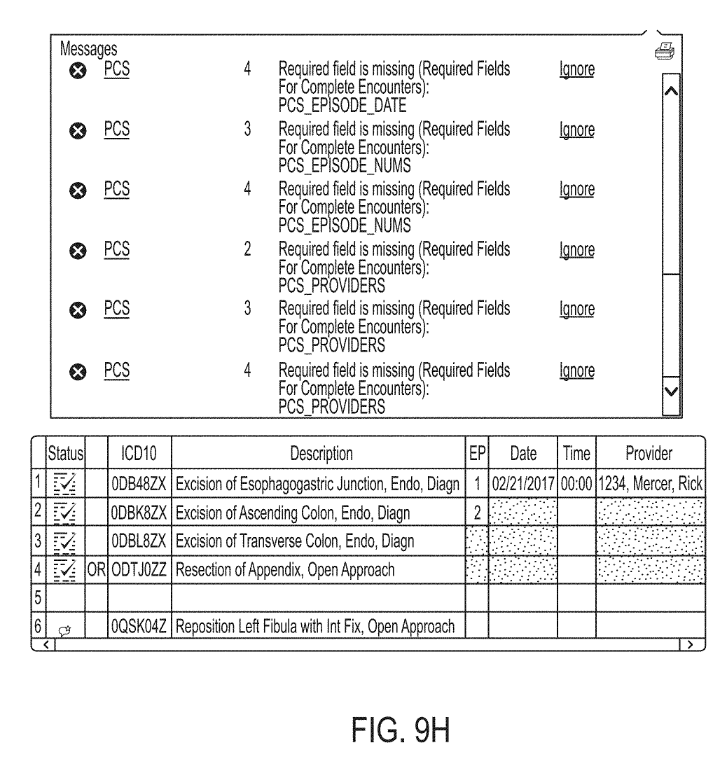

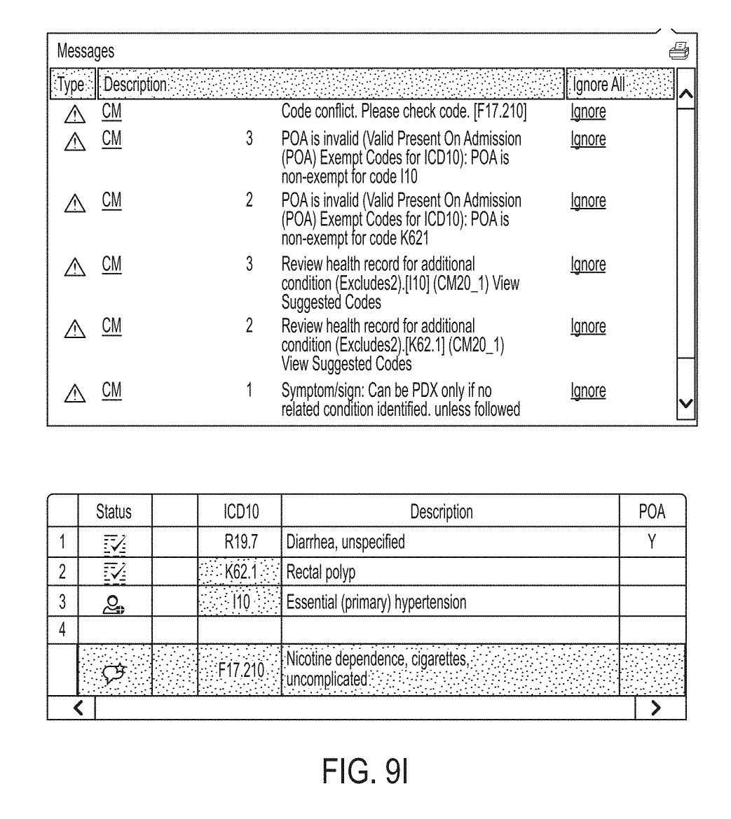

In other embodiments, exemplary CAC GUI 700 may be extended to provide some or all of the functionality illustrated in the example of FIG. 8, without removing the user from the CAC workspace to a separate screen. FIG. 9A, for instance, illustrates an exemplary embodiment in which GUI 700 is extended to include editable POA fields (on the right-hand side of code list panel 730) and editable code sequencing fields (on the left-hand side of panel 730) for the set of billing codes under consideration for the patient encounter. In the example shown in FIG. 9A, the numerals 1 through 8 on the left-hand side of panel 730 indicate the current sequence of the user-approved codes, with the numeral 1 indicating that “Acute Respiratory Failure” (ICD-9-CM code 518.81) is the principal diagnosis, the numeral 2 indicating that “Thrombocytopenia NOS” (ICD-9-CM code 287.5) is the next secondary diagnosis, etc. (“Cirrhosis of Liver w/o Alcohol” (ICD-9-CM code 571.5) is a rejected code, and therefore does not receive a numeral in the sequence of user-approved codes for the patient encounter.) The sequence in which the user-approved billing codes for the patient encounter are finalized may be significant in determining the level of reimbursement for the patient encounter, e.g., by determining the diagnosis related group (DRG) of the patient encounter.

In some embodiments, as illustrated in FIG. 9A, CAC GUI 700 may provide further functionality in displaying the DRG determined by the current set of user-approved codes and their sequence (as well as any other relevant data, such as the POA data, patient demographic data, etc.) for the patient encounter. For example, exemplary GUI 700 in FIG. 9A includes a panel 760 in which the current DRG is displayed. In some embodiments, the CAC system may automatically correlate the current set of user-approved billing codes to the appropriate DRG to provide this display. This may be done, for example, using a stored set of DRG rules. In the example in FIG. 9A, the fact that code 518.81 for “Acute Respiratory Failure” has been placed first in the code sequence and therefore designated the principal diagnosis for the patient encounter gives rise to a DRG for the patient encounter of 189 (“Pulmonary Edema & Respiratory Failure”).

In some embodiments, CAC GUI 700 may allow the user to change the sequencing of the set of user-approved billing codes before finalizing them. This may be done in any suitable way. For instance, FIG. 9B illustrates an example in which the numerals at the left-hand side of code list panel 730 are editable to change the code sequence. In this example, the user has changed the sequence number of code 482.1 (“Pneumonia due to Pseudomonas”) to 1, indicating that this is the principal diagnosis. In this example, the CAC system has then automatically renumbered the rest of the user-approved codes to follow in sequence behind that principal diagnosis. Although not done in this example, in another example the codes could be reorganized within panel 730 such that the principal diagnosis (corresponding to numeral 1) always appears at the top of the panel, followed underneath by each successive numbered code in sequence, with non-approved (unnumbered) codes at the bottom of the panel, etc. In another example, the user input to modify the sequence of the user-approved codes may be in the form of dragging the codes to change their physical order within panel 730 (e.g., dragging a code to the top of the panel to make it the principal diagnosis), in response to which the CAC system may automatically renumber the codes accordingly. It should be appreciated that embodiments are not limited to any particular form of user input to modify the sequence of user-accepted codes for a patient encounter.

In some embodiments, in response to a user's modification of the sequence of user-approved billing codes for the current patient encounter, the CAC system may automatically update the DRG based on the modified sequence of user-approved codes, and may display the updated DRG in the GUI. FIG. 9B shows the example in which the user has changed the principal diagnosis from code 518.81 (“Acute Respiratory Failure”) to code 482.1 (“Pneumonia due to Pseudomonas”). In response, the automatically determined DRG displayed in panel 760 has been updated from DRG 189 (“Pulmonary Edema & Respiratory Failure”) to DRG 193 (“Simple Pneumonia & Pleurisy w MCC”). The fact that acute respiratory failure is the second diagnosis in the sequence and was not present on admission indicates that there was a major complication (“MCC”) to the principal diagnosis of pneumonia, leading to this specific updated DRG. In some embodiments (not shown in FIG. 9B), GUI 700 may also display information indicating the level of reimbursement associated with the currently applicable DRG, allowing the coder to appreciate how individual modifications to the code set and sequence for the patient encounter may affect the reimbursement level. Some embodiments may provide an option for the CAC system to automatically determine the best sequencing for the current set of user-approved billing codes to result in the most appropriate DRG for the patient encounter. For example, in some embodiments, an automatic code sequencing feature may sequence codes such that any codes that would have an effect on the DRG are placed close enough to the top of the sequence (i.e., close enough to code #1, the principal diagnosis) for their effect on the DRG to be realized. In another example, some embodiments of an automatic code sequencing feature may sequence codes such that complication and major complication codes are placed close to the top of the sequence.

In some embodiments, in response to user input that changes the set of user-approved billing codes for the patient encounter by approving or removing approval of an engine-suggested code via the GUI, the CAC system may likewise automatically update the DRG based on the changed set of user-approved billing codes and display the updated DRG in the GUI. FIG. 9C shows an example in which the user, proceeding from the screen shown in FIG. 9B, has now removed approval of code 518.81 (“Acute Respiratory Failure”) by changing that code's status from “accepted” back to merely “engine-suggested.” In response, the remaining user-approved codes that were lower in the sequence than code 518.81 (which was previously second in the sequence) have now been renumbered, and code 518.81 is no longer part of the sequence. Also, the CAC system has updated the DRG displayed in panel 760 from DRG 193 (“Simple Pneumonia & Pleurisy w MCC”) to DRG 195 (“Simple Pneumonia & Pleurisy w/o CC/MCC”), since there is now no code for a complication or major complication of the pneumonia appearing in the user-approved code set for the patient encounter. In some embodiments, such immediate updating of the automatically determined and displayed DRG may allow the user to better appreciate the immediate effects on reimbursement level as the user reviews and acts on engine-suggested codes (e.g., by accepting, rejecting, replacing, ignoring, etc.).

Some embodiments may alternatively or additionally provide other extended functionality in a unified CAC/coding interface. For example, in some embodiments, patient demographic information and/or other encounter-level data for the patient encounter may be displayed and made editable in the CAC GUI, which may thus accept user input to change any of the editable information during coding. FIG. 9D illustrates an example in which GUI 700 includes a panel 770 with various editable fields for patient demographic information and other encounter-level data. Any suitable such data may be displayed and/or made editable within CAC GUI 700, as embodiments are not limited in this respect. Examples of suitable patient demographic information and/or other encounter-level data that may be displayed and/or edited include, but are not limited to, patient name, age, sex, date of birth, height, weight, date of admission to the healthcare facility, time of admission, date of discharge, time of discharge, provider name(s), coder name(s), etc.

In some embodiments, in response to receiving user input changing patient demographic information or other encounter-level data via the GUI, the CAC system may apply the NLU engine to update the engine-suggested billing codes for the patient encounter based on the changed patient demographic information or other encounter-level data. For example, a change to the patient's age or sex may make certain engine-suggested codes (codes related to childbirth, for example, or prostate disease, or geriatric conditions, etc.) more or less probable than they were before the change. Alternatively or additionally, in some embodiments a user's change to patient demographic information or other encounter-level data may trigger a corresponding update to the automatically determined DRG for the patient encounter.

In some embodiments, a unified CAC/coding interface may include functionality to provide coding alerts to the user in the process of manually adding billing codes and/or reviewing engine-suggested codes. FIG. 9D illustrates an example in GUI 700 in which an icon 780 provides an indication of whether there are alerts (and optionally how many) triggered by the current set of user-approved codes and their associated data. Any suitable alerts may be provided; some possible examples are illustrated in FIGS. 9E-9I. For example, alerts may be provided when information required to be provided along with a particular code has not yet been provided, when additional codes required to be included along with a particular code have not yet been entered, etc. In some embodiments, in connection with the alerts, the codes to which the alerts apply may be visually distinguished in panel 730 in any suitable way, such as through highlighting, outlining, font changes, added icons or symbols, etc. In another specific example, an alert may be provided when a code that was approved by the coder is later rejected in compliance review; this example is illustrated in FIG. 9I, in which engine-suggested code F17.210 was initially accepted by the coder but later rejected in compliance review. In the example in FIG. 9I, the code's status is changed back to merely “engine-suggested” instead of “engine suggested and user-accepted,” and a “code conflict” alert is generated.

This example illustrates a scenario in which a finalized or unfinalized set of codes for a patient encounter may be saved and exported from the CAC application, operated on and modified in a different application, and then returned to the CAC application for further review and possible modification by the coder. In the compliance example, some subset of patient encounters may be subject to further review after initial coding, for quality assurance purposes. Some codes may be changed in the process, and the modified set of codes for the patient encounter may then be returned to the CAC application for final review and submission to a billing process. In another example, coders may save their work on coding a patient encounter at intermediate stages, while waiting for further documentation for the patient encounter to become available after some coding work has already been done, etc. For example, in some embodiments, GUI 700 may include a “Save” button instead of or as an alternative in addition to “Submit” button 750, or “Submit” option 750 may be configured to prompt the user with a choice to select whether to save the current session's codes as an intermediate unfinalized set or as a complete finalized set of codes ready for billing, or an intermediate save option may be provided in any other suitable way. The process of coding a patient encounter may span a number of separate sessions in the CAC application, with the incomplete/unfinalized set of codes for the patient encounter being saved in another location (e.g., in the patient's EHR) in between sessions and then returned to the CAC application.

In some embodiments, when an intermediate set of codes for a patient encounter is exported from and later returned to the CAC application in the midst of the coding process for the encounter, identifier data may be maintained in association with each code to inform the CAC application, when the codes are returned, as to which codes were suggested by the NLU engine, which were added by the user in the CAC application, which were added elsewhere, etc. This information may be useful, for example, in determining which code should take precedence when two codes overlap, which codes should be used for training feedback for the NLU engine, which codes are linked to which portions of the documentation text, etc. However, in other embodiments, identifier data for the source/history of each code may not be retained when the code sets are exported from and later reimported to the CAC application. In some such embodiments, a suitable process may be applied to match incoming codes to codes currently being suggested by the NLU engine. In some embodiments, when an incoming code is matched to a current engine-suggested code in the CAC application, the codes may be merged into a single code linked to the supporting portion(s) of the documentation text for the engine-suggested code. In some embodiments, merged matched codes may be treated as user-approved codes by the CAC application.

Any suitable process may be used to match incoming billing codes to engine-suggested codes in the CAC application. Listed below is one example of a suitable process; however, others are possible.

The table below lists the fields that may be considered for matching purposes for different types of codes in the exemplary matching process:

| Code Type | Fields to be matched |
|---|---|
| Diagnosis codes (DX and CM) | Code Value, POA |
| Procedure Codes (PX and PCS) | Code Value, Episode Number, |
| | Operation Date, Provider |
| HCPCS | Code Value, Episode Number, |
| | Operation Date, Provider, Modifiers |

Matching Logic:
1. If there are no duplicate codes (i.e. a one-to-one match on code value), identity that codes both are same.
2. If there are duplicates, try to find the best match by comparing all the above fields
   a. For PX/PCS—find next best match by repeatedly comparing fewer fields.
      1^{st} iteration compare all the above fields.
      Next iteration compare Code Value, Episode, provider.
      Next iteration, compare Code value, Episode.
   b. For HCPCS—find next best match by repeatedly comparing fewer fields.
      1^{st} iteration compare with all fields.
      Next iteration, compare Code value, episode, provider, date.
      Next Iteration, compare Code value, episode, Provider.
      Next iteration, compare Code value, Episode

In some embodiments, if an engine-suggested code that was accepted by the user in a previous session in the CAC application later has no matching code in a full set of codes for the patient encounter returned to the CAC application from another application, that engine-suggested code may then be presented in the CAC GUI as merely “suggested” (and no longer “accepted”), and an alert may be provided to the user. In some embodiments, if a code that was entered by the user as a replacement code for an engine-suggested code in a previous session in the CAC application later has no matching code in a full set of codes for the patient encounter returned to the CAC application from another application, that replacement code may then be presented in the CAC GUI as “suggested,” and an alert may be provided to the user.

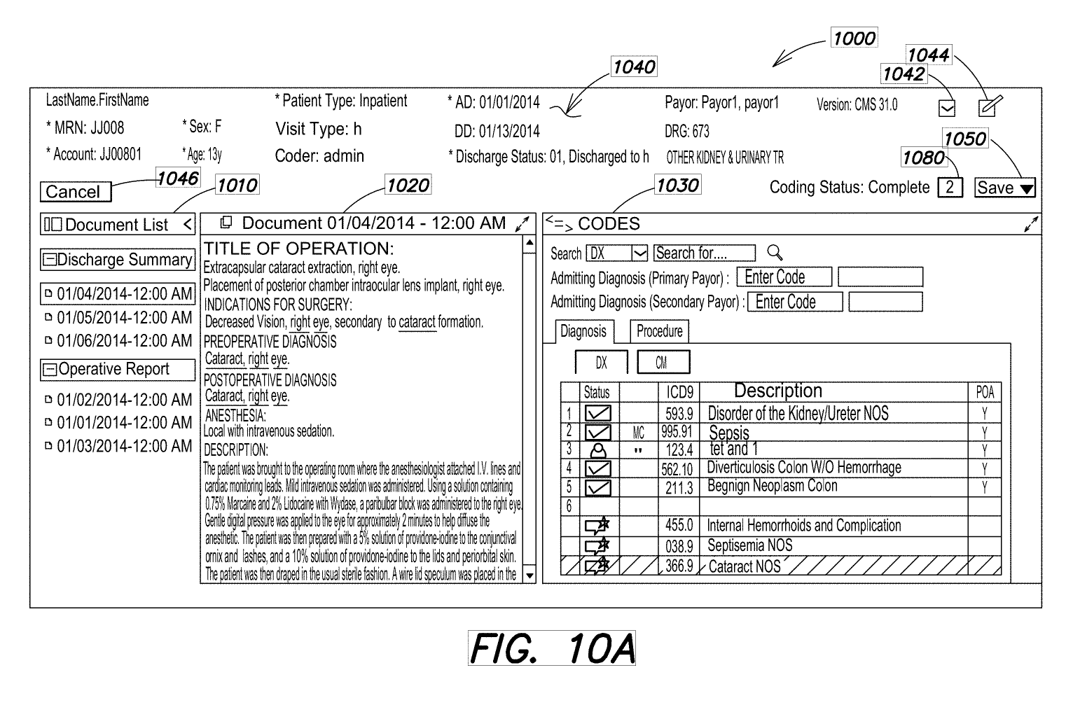

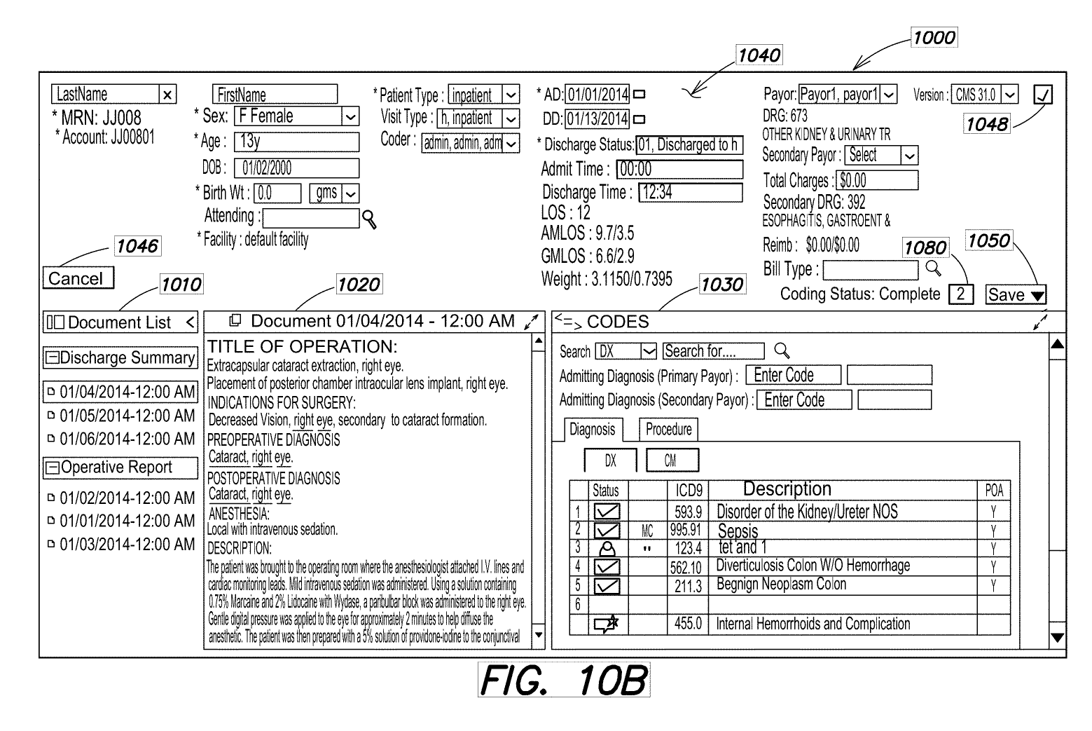

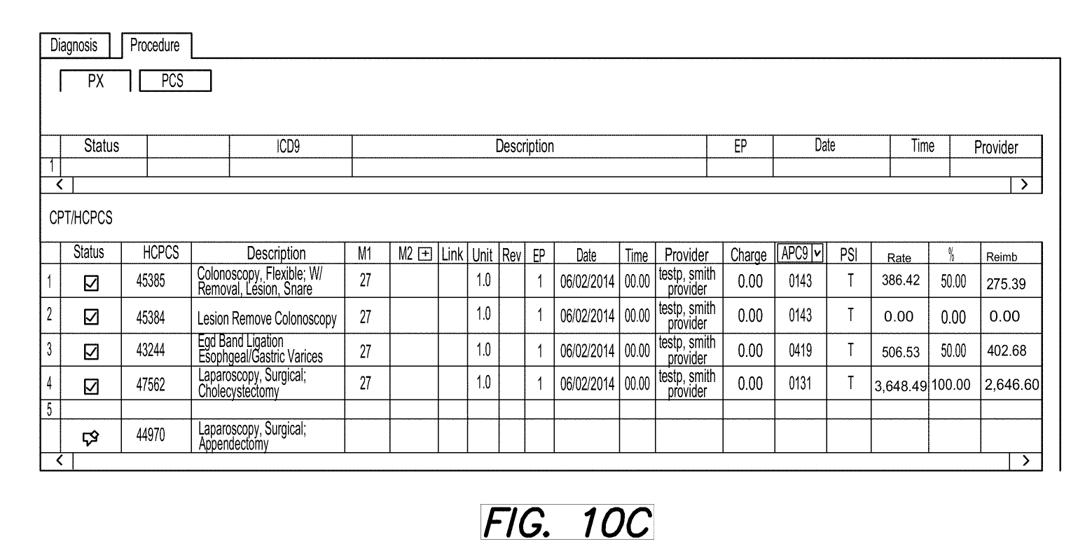

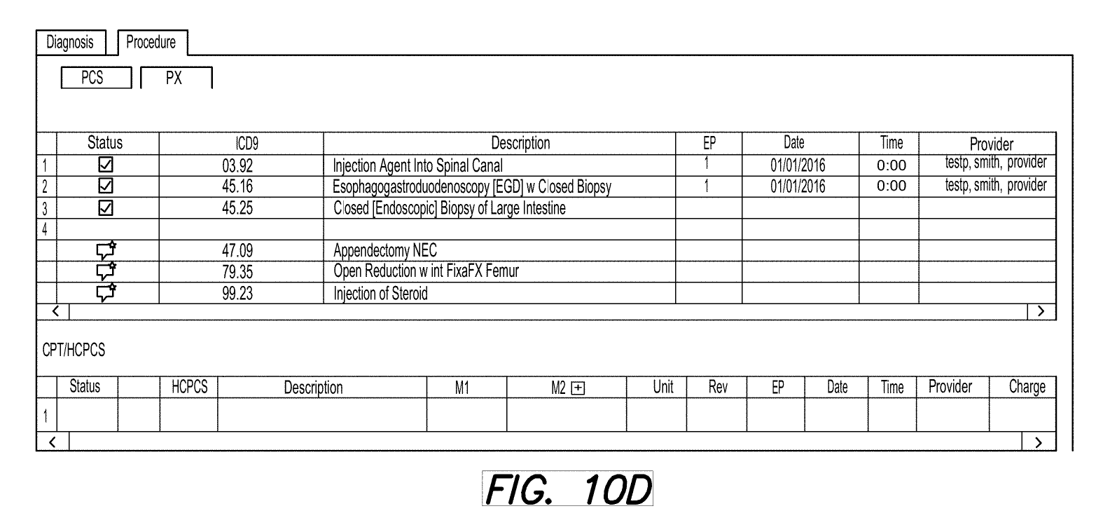

FIGS. 10A and 10B provide another example of a suitable GUI 1000 for an integrated CAC system in accordance with some embodiments. Similar to GUI 700 described above, the exemplary GUI 1000 of FIGS. 10A and 10B includes a document list 1010, a document viewer 1020, and a code list panel 1030 including editable code sequencing and POA indicators, as well as an upper panel 1040 providing editable patient demographic information and other encounter-level data, automated DRG calculation and display, and coding rule alerts. In contrast to GUI 700's “Submit” button 750, the exemplary GUI 1000 of FIGS. 10A and 10B includes a “Save” button 1050 that may be selected to save the current set and sequence of codes for the patient encounter, either in an intermediate unfinalized state or as the finalized code set for the patient encounter to be forwarded, e.g., to a billing process. In the example of FIGS. 10A and 10B, the “Save” button 1050 includes a drop-down option that allows the user to choose between the intermediate unfinalized save and the finalizing “coding complete” save.

In more detail: The upper panel 1040 of exemplary GUI 1000 displays a number of fields containing patient demographic information and other encounter-level data. The specific examples of such fields and data illustrated in FIGS. 10A and 10B are provided merely for purposes of illustration and are not intended to be limiting, unless otherwise indicated herein. Also, such encounter-level data is not limited to being displayed in an upper panel, but may be displayed in any suitable location(s) in a user interface. The “LastName.FirstName” field in the example of FIG. 10A provides the name of the patient involved in the patient encounter. The value in the “MRN” field is a Medical Record Number that corresponds to that patient (and that patient's medical record). The value in the “Account” field is an identifier corresponding to the particular encounter currently being coded. The value in the “Sex” field is “M” for “male,” “F” for “female,” “U” for “unspecified,” etc., corresponding to the patient's sex. The value in the “Age” field is the patient's age (e.g., in years). The value in the “Patient Type” field indicates whether the encounter was inpatient or outpatient. The value in the “Visit Type” field is configurable by the institution, and can indicate one of a number of different types of inpatient encounters when the patient type is “inpatient” (e.g., Cardiology, Maternity, ICU (intensive care unit), etc.), and one of a number of different types of outpatient encounters when the patient type is “outpatient” (e.g., “ER,” “Same Day Surgery,” “Observation,” etc.). The value in the “Coder” field is an identifier (e.g., a user name) of the user completing the coding of the patient encounter. The value in the “AD” field is the date on which the patient was admitted (e.g., to the hospital). The value in the “DD” field is the date on which the patient was discharged. The value in the “Discharge Status” field indicates where the patient was discharged to (e.g., to home, to a nursing facility, expired (died in the hospital), etc.). The value in the “Payor” field is an identifier of the primary payor (e.g., a government program such as Medicare, an insurance company, etc.) who will reimburse the institution for the services provided in the patient encounter. The value in the “DRG” field is the diagnosis related group for the patient encounter. In some embodiments, the DRG may be determined automatically as described above. The value in the “Version” field identifies the grouper used by the primary payor. As is known in the art, the grouper logic specified by a particular payor typically influences how the DRG is calculated.

Upper panel 1040 in exemplary GUI 1000 is displayed in FIG. 10A in a condensed view in which the data fields are not editable. In this example, upper panel 1040 in the condensed view includes an expand button 1042 selectable to expand the upper panel 1040 to display more data fields, as well as an expand-and-edit button 1044 to display more data fields and make appropriate data fields editable. FIG. 10B illustrates an example of an expanded upper panel 1040 with editable data fields, which may be provided in response to user selection of button 1044. In this exemplary GUI 1000, selection of button 1042 would have displayed the same data fields in upper panel 1040 as illustrated in FIG. 10B, but without allowing the user to edit the data. In the example editable view of FIG. 10B, a button 1048 is provided, which the user may select to cause any edits that have been entered into editable fields of upper panel 1040 to be saved to the patient's medical record, and the upper panel 1040 to be returned to the condensed view of FIG. 10A with any edited fields updated to display the edited values.

The example expanded upper panel 1040 of FIG. 10B includes a number of additional fields showing patient demographic information and other encounter-level data that were not visible in the condensed view of FIG. 10A. The value in the “DOB” field is the patient's date of birth. The value in the “Birth Wt” field is the patient's birth weight, and the units for this measurement (e.g., “gms” for grams) are selectable. The value in the “Attending” field is an identifier indicating the patient's attending physician for this encounter. The value in the “Facility” field indicates the facility (e.g., hospital, medical office, etc.) where the patient was treated. The value in the “Admit Time” field is the time of day at which the patient was admitted. The value in the “Discharge Time” field is the time of day at which the patient was discharged. The value in the “LOS” field is the patient's length of stay at the hospital or other treatment location (e.g., in days, or in hours, etc.). The value in the “AMLOS” field is the hospital's or other institution's average length of stay measured as an arithmetic mean across patients. The value in the “GMLOS” field is the average length of stay measured as a geometric mean. The “Secondary Payor” field allows for a secondary payor to be associated with the patient encounter (e.g., for reporting). In some cases, different grouper logic may be specified by the secondary payor, which could result in a different DRG for the secondary payor for the same coded encounter. The use of more than one grouper can also result in more than one value for AMLOS and GMLOS, with each AMLOS value and each GMLOS value being specific to a different grouper. The value in the “Total Charges” field in the example GUI 1000 is the total monetary amount of services performed in the patient encounter, not specific to any payor. The value in the “Secondary DRG” field is the diagnosis related group calculated for the secondary payor, which as discussed above may be different from the value in the “DRG” field calculated using the grouper logic of the primary payor. The value in the “Weight” field is a relative weight assigned to each DRG, which may be used as part of the pricing/reimbursement process. The value in the “Reimb” field indicates the reimbursement amount for the services provided, as determined based on the DRG for the primary payor. The value in the “Bill Type” field is a predefined set of three character values that indicate the type of services rendered during the visit. In the example of FIG. 10B, the patient's name, sex, age, date of birth, birth weight, attending physician, patient type, visit type, coder, admit date and time, discharge date and time, discharge status, payors, grouper version, total charges, and bill type are made editable via the expanded upper panel 1040.

In the example GUI 1000, the document list 1010 and the document viewer 1020 include the same functionality as the corresponding panels 710 and 720 discussed above in connection with example GUI 700. The code list 1030 also includes the functionality of corresponding code list panel 730 extended as in FIG. 9A described above, as well as some additional functionality. The “Search” field in code list panel 1030 allows the user to enter one or more keywords in the text box and search (e.g., in a codebook) for codes matching those keywords. The adjacent drop-down menu allows the user to select in which codebook to search (e.g., for diagnoses vs. procedures). The Admitting Diagnosis (Primary Payor) field allows the user to enter a code corresponding to the diagnosis that the patient was given around the time of admission, using the code set for the primary payor. The Admitting Diagnosis (Secondary Payor) field allows the user to enter a different code for the same diagnosis if the secondary payor uses a different code set.

The “Diagnosis” tab in code list panel 1030 (and in code list panel 730) shows the current list of diagnosis codes for the patient encounter, and the “Procedure” tab in code list panel 1030 (and in code list panel 730) shows the current list of procedure codes for the encounter. In code list panel 1030, the “DX” tab shows ICD-9 codes within the “Diagnosis” tab, and the “CM” tab shows ICD-10 codes within the “Diagnosis” tab. In the example illustrated in FIGS. 10A and 10B, the “Diagnosis” and “DX” tabs are currently open. Like code list panel 730 expanded as in FIG. 9A, code list panel 1030 in FIGS. 10A and 10B includes columns for editable code sequence numbers (on the left-hand side of the panel) and editable POA indicators (on the right-hand side of the panel). Code list panel 1030 also includes an additional column displaying symbols (e.g., “MC” for “major complication”) for codes that are flagged as impacting the DRG. In the “Status” column of code list panel 1030, checked boxes indicate user-accepted engine-suggested codes, person-like icons indicate user-added codes, and starred speech bubble icons indicate engine-suggested codes (which have not yet been user-accepted). The highlighted row in code list panel 1030 in FIG. 10A indicates an engine-suggested code (366.9 for “Cataract NOS”) that is currently selected such that the linked evidence text in document viewer 1020 (“cataract,” “right eye,” etc.) is indicated by underlining.

It should be appreciated that any one, some, or all of the data items indicated above as being editable fields may be made user-editable in various implementations, and embodiments are not limited to the specific data items listed above, nor to the specific subset of the data items made editable in the examples given herein. Some embodiments may not make all of the fields editable that are described as editable in the examples herein, and some embodiments may make additional fields editable that are not described as editable in the examples herein.

Further included in exemplary GUI 1000 is a coding status indication field (in upper panel 1040 in the example of FIGS. 10A and 10B, although the status field may be in any suitable location) indicating whether the coding of the patient encounter is currently saved as complete, or is in a different status (e.g., incomplete, unfinalized). Also included in exemplary GUI 1000 is a coding alerts indicator 1080, which has the same functionality as the corresponding indicator 780 described above in connection with exemplary GUI 700. In some embodiments, a user may select (e.g., click on) indicator 1080 (and likewise indicator 780) to view any alerts that have been triggered on the currently pending code set for the patient encounter. Exemplary GUI 1000 further provides a “Cancel” button 1046 that may be selected by the user to discard any updates that the user has made to the record via GUI 1000 since the last save.

FIGS. 10C and 10D provide illustrations of an example “Procedure” tab in code list panel 1030 of exemplary GUI 1000. Within this “Procedure” tab, the “PX” tab shows ICD-9 and CPT/HCPCS codes, while the “PCS” tab shows ICD-10 codes. FIGS. 10C and 10D both illustrate examples where the “PX” tab is currently open; FIG. 10C shows example CPT/HCPCS codes, and FIG. 10D shows example ICD-9 procedure codes.

In the example CPT/HCPCS code list of FIG. 10C, a number of columns of fields are provided, any one, some, or all of which fields can be made user-editable in various implementations. In the example illustrated in FIG. 10C, the “Status” column includes an indicator for each code of whether the code is engine-suggested, user-added, user-accepted, etc., as in the status column of FIGS. 10A and 10B. The “HCPCS” column includes each coded procedure's HCPCS code number. The “Description” column includes the textual description corresponding to each code. In some embodiments, this description may not be editable directly, but each may be a standard description corresponding to a particular code number, such that editing the code number changes the description correspondingly. In some embodiments, a user and/or an institution may create alternate descriptions for individual codes, such that the “Description” field may be editable to select among the available alternate descriptions and/or to enter an alternate description. The “M1” and “M2” columns (and “M3” and further columns that can be added via the “+” button) are for entering/selecting CPT/HCPCS modifier codes. The “Link” column allows the user to link the procedure coded in that row to a particular diagnosis, by entering the row number of the diagnosis from the diagnosis code list in the “Link” field. The “Unit” column includes the number of units of service for each code (i.e., the number of procedures of that code performed on the patient). The “Rev” column can include a revenue code for a coded procedure, which can be used in calculating pricing/payment for a procedure service provided, without an outpatient procedure code like CPT/HCPCS. The “EP” column includes the number of the episode in which each coded procedure was performed. (As is known in the art, a patient's stay at, e.g., a hospital may span a number of “episodes,” in which different sets of procedures may be performed. For example, a first set of procedures may be performed in a first episode, and then a second set of procedures may be performed in a second episode after a period of observation between the two episodes.) The “Date” and “Time” columns include the date and time of the episode, respectively, for each coded procedure. The “Provider” field includes an identifier of the clinician who performed each procedure. The “Charge” column includes a monetary charge corresponding to each coded procedure. In some embodiments, the “Charge” field may not be made user-editable, but may be a standard charge corresponding to the coded procedure, such that editing the procedure code may change the charge correspondingly. The “APC9” column indicates the Ambulatory Payment Classification for ICD-9 for each coded procedure. APC9 is one possible outpatient grouper that can be selected; others may be made available via the drop-down menu at the top of that column. The “PSI” column includes Payment Status Indicators that provide information on how the APC will be paid. The “Rate” column includes values used in payment calculations. The “%” column indicates discounts or other adjustments that may affect the percentage of the Rate to be used in the payment calculation. The “Reimb” column indicates the end result of the payment calculation, which is the reimbursement amount for each coded procedure.

In the example ICD-9 code list of FIG. 10D, a number of columns of fields are provided, any one, some, or all of which fields can likewise be made user-editable in various implementations. In this example, the “ICD9” column includes each coded procedure's ICD-9 code number. The “Status,” “Description,” “EP,” “Date,” “Time,” and “Provider” columns are the same as for the HCPCS code list, but applied to the ICD-9 codes.

In some embodiments, a CAC interface such as the exemplary GUI 1000 shown in FIGS. 10A-10D may provide the user with interactive access to a coding-related knowledge base including the government-authorized codebooks for the standardized code sets being used to code the patient encounter. The GUI may be configured to allow the user to call up an appropriate codebook, for example, as part of reviewing and potentially correcting an engine-suggested code in the code list. This may be done in any suitable way. Examples of suitable techniques for providing an integrated codebook interface are described in U.S. patent application Ser. No. 14/296,214, filed Jun. 4, 2014, and entitled “Medical Coding System with Integrated Codebook Interface.” The disclosure of that patent application is hereby incorporated herein by reference in its entirety. Such an integrated codebook interface may be invoked in any suitable way within the CAC interface. For example, in some embodiments, a row within code list panel 1030 of exemplary GUI 1000 (or similarly within code list panel 730 of exemplary GUI 700) may be selected (e.g., by right-clicking) to bring up a context menu similar to the illustration in FIG. 7C. That context menu may include a “Verify” option that may be selectable to bring up the appropriate codebook open to the entry corresponding to the selected code.

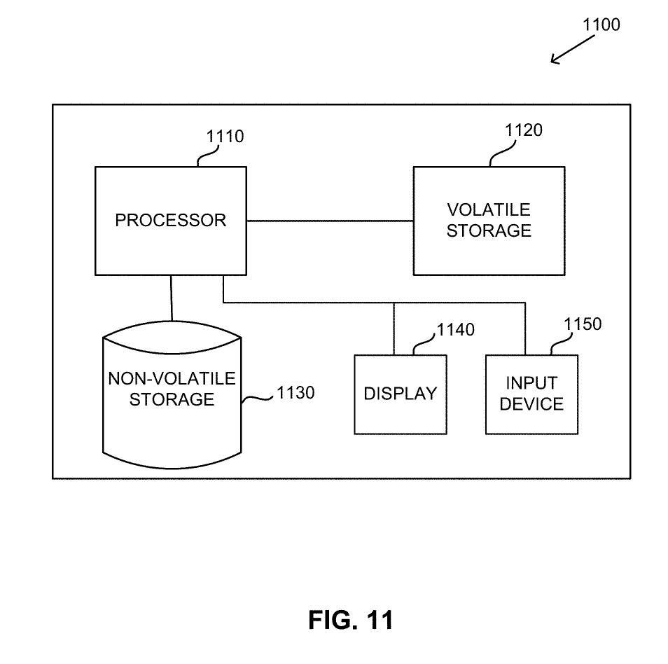

Like the embodiments of the CLU system 100 described above, the CAC system in accordance with the techniques described herein may take any suitable form, as embodiments are not limited in this respect. An illustrative implementation of a computer system 1100 that may be used in connection with some implementations of a CAC system is shown in FIG. 11. One or more computer systems such as computer system 1100 may be used to implement any of the functionality of the CAC system described above. As shown, the computer system 1100 may include one or more processors 1110 and one or more tangible, non-transitory computer-readable storage media (e.g., volatile storage 1120 and one or more non-volatile storage media 1130, which may be formed of any suitable non-volatile data storage media). The processor 1110 may control writing data to and reading data from the volatile storage 1120 and the non-volatile storage media 1330 in any suitable manner, as embodiments are not limited in this respect. To perform any of the functionality described herein, the processor 1110 may execute one or more instructions stored in one or more computer-readable storage media (e.g., volatile storage 1120), which may serve as tangible, non-transitory computer-readable storage media storing instructions for execution by the processor 1110. In some embodiments, computer system 1100 may include one or more displays 1140 and/or one or more input devices 1150, which may be used to provide a user interface with input and/or output capability. In some embodiments, the display(s) 1140 and input device(s) 1150 may be separate devices or separable components; while in other embodiments, the display(s) 1140 and input device(s) 1150 may be integrated in any suitable manner, such as in a touchscreen device that performs both input and output functions via a single screen.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with non-dedicated hardware (e.g., one or more processors) that is programmed using microcode or software to perform the functions recited above.

In this respect, it should be appreciated that one implementation of some embodiments comprises at least one computer-readable storage medium (i.e., a tangible, non-transitory computer-readable medium, such as a computer memory, a floppy disk, a compact disk, a magnetic tape, or other tangible, non-transitory computer-readable medium) encoded with a computer program (i.e., a plurality of instructions), which, when executed on one or more processors, performs above-discussed functions. The computer-readable storage medium can be transportable such that the program stored thereon can be loaded onto any computer resource to implement functionality discussed herein. In addition, it should be appreciated that the reference to a computer program which, when executed, performs any of the above-discussed functions, is not limited to an application program running on a host computer. Rather, the term “computer program” is used herein in a generic sense to reference any type of computer code (e.g., software or microcode) that can be employed to program one or more processors to implement above-discussed functionality.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
at least one display;
at least one input device;
at least one processor; and
at least one storage medium storing processor-executable instructions that, when executed by the at least one processor, perform a method comprising:
applying a natural language understanding engine to a free-form text documenting a clinical patient encounter, to automatically derive one or more engine-suggested medical billing codes for the clinical patient encounter;
presenting the engine-suggested medical billing codes for the clinical patient encounter in a graphical user interface (GUI) via the at least one display;
accepting user input via the at least one input device to approve at least one of the engine-suggested medical billing codes and/or to enter one or more user-added medical billing codes for the clinical patient encounter in the GUI, resulting in a set of user-approved medical billing codes for the clinical patient encounter;
automatically correlating the set of user-approved medical billing codes to a diagnosis related group (DRG) for the clinical patient encounter and displaying the DRG in the GUI via the at least one display; and
in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.

2. The system of claim 1, wherein the method further comprises presenting the engine-suggested medical billing codes and the user-added medical billing codes for the clinical patient encounter together in a same window in the GUI.

3. The system of claim 1, wherein the method further comprises receiving user input via the GUI to link a user-added medical billing code to a portion of the free-form text providing evidence for the linked user-added medical billing code being applicable to the clinical patient encounter.

4. The system of claim 1, wherein the method further comprises, in response to receiving a user-added medical billing code for the clinical patient encounter, applying the natural language understanding engine to automatically identify a portion of the free-form text providing evidence for the received user-added medical billing code being applicable to the clinical patient encounter.

5. The system of claim 1, wherein the method further comprises, in response to receiving a user-added medical billing code for the clinical patient encounter, automatically deriving an additional engine-suggested medical billing code made applicable to the clinical patient encounter by the received user-added medical billing code.

6. The system of claim 1, wherein the method further comprises, in response to receiving an additional medical billing code added external to the GUI for the clinical patient encounter, automatically determining whether the additional medical billing code is a duplicate of an engine-suggested medical billing code for the clinical patient encounter.

7. The system of claim 6, wherein the method further comprises, in response to determining that the additional medical billing code is a duplicate of a first engine-suggested medical billing code linked to a first portion of the free-form text, linking the additional medical billing code to the first portion of the free-form text.

8. The system of claim 1, wherein the method further comprises:
displaying patient demographic information for the clinical patient encounter in the GUI via the at least one display; and
accepting user input via the at least one input device to change the patient demographic information for the clinical patient encounter in the GUI.

9. The system of claim 8, wherein the method further comprises, in response to receiving user input changing the patient demographic information in the GUI:
applying the natural language understanding engine to update the engine-suggested medical billing codes for the clinical patient encounter based on the changed patient demographic information; and
presenting the updated engine-suggested medical billing codes for the clinical patient encounter in the GUI via the at least one display.

10. The system of claim 1, wherein the method further comprises providing, in the GUI, a selectable option to send the set of user-approved medical billing codes as a finalized set of medical billing codes for the clinical patient encounter to a billing process.

11. At least one non-transitory computer-readable storage medium storing computer-executable instructions that, when executed, perform a method comprising:
applying a natural language understanding engine to a free-form text documenting a clinical patient encounter, to automatically derive one or more engine-suggested medical billing codes for the clinical patient encounter;
presenting the engine-suggested medical billing codes for the clinical patient encounter in a graphical user interface (GUI) via at least one display;
accepting user input via at least one input device to approve at least one of the engine-suggested medical billing codes and/or to enter one or more user-added medical billing codes for the clinical patient encounter in the GUI, resulting in a set of user-approved medical billing codes for the clinical patient encounter;
automatically correlating the set of user-approved medical billing codes to a diagnosis related group (DRG) for the clinical patient encounter and displaying the DRG in the GUI via the at least one display; and
in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.

12. The at least one non-transitory computer-readable storage medium of claim 11, wherein the method further comprises presenting the engine-suggested medical billing codes and the user-added medical billing codes for the clinical patient encounter together in a same window in the GUI.

13. The at least one non-transitory computer-readable storage medium of claim 11, wherein the method further comprises receiving user input via the GUI to link a user-added medical billing code to a portion of the free-form text providing evidence for the linked user-added medical billing code being applicable to the clinical patient encounter.

14. The at least one non-transitory computer-readable storage medium of claim 11, wherein the method further comprises, in response to receiving a user-added medical billing code for the clinical patient encounter, applying the natural language understanding engine to automatically identify a portion of the free-form text providing evidence for the received user-added medical billing code being applicable to the clinical patient encounter.

15. The at least one non-transitory computer-readable storage medium of claim 11, wherein the method further comprises, in response to receiving a user-added medical billing code for the clinical patient encounter, automatically deriving an additional engine-suggested medical billing code made applicable to the clinical patient encounter by the received user-added medical billing code.

16. The at least one non-transitory computer-readable storage medium of claim 11, wherein the method further comprises:
in response to receiving an additional medical billing code added external to the GUI for the clinical patient encounter, automatically determining whether the additional medical billing code is a duplicate of an engine-suggested medical billing code for the clinical patient encounter; and
in response to determining that the additional medical billing code is a duplicate of a first engine-suggested medical billing code linked to a first portion of the free-form text, linking the additional medical billing code to the first portion of the free-form text.

17. The at least one non-transitory computer-readable storage medium of claim 11, wherein the method further comprises:
displaying patient demographic information for the clinical patient encounter in the GUI via the at least one display; and
accepting user input via the at least one input device to change the patient demographic information for the clinical patient encounter in the GUI.

18. The at least one non-transitory computer-readable storage medium of claim 17, wherein the method further comprises, in response to receiving user input changing the patient demographic information in the GUI:
applying the natural language understanding engine to update the engine-suggested medical billing codes for the clinical patient encounter based on the changed patient demographic information; and
presenting the updated engine-suggested medical billing codes for the clinical patient encounter in the GUI via the at least one display.

19. The at least one non-transitory computer-readable storage medium of claim 11, wherein the method further comprises providing, in the GUI, a selectable option to send the set of user-approved medical billing codes as a finalized set of medical billing codes for the clinical patient encounter to a billing process.

20. A method comprising:
applying a natural language understanding engine, implemented via at least one processor, to a free-form text documenting a clinical patient encounter, to automatically derive one or more engine-suggested medical billing codes for the clinical patient encounter;
presenting the engine-suggested medical billing codes for the clinical patient encounter in a graphical user interface (GUI) via at least one display;
accepting user input via at least one input device to approve at least one of the engine-suggested medical billing codes and/or to enter one or more user-added medical billing codes for the clinical patient encounter in the GUI, resulting in a set of user-approved medical billing codes for the clinical patient encounter;
automatically correlating the set of user-approved medical billing codes to a diagnosis related group (DRG) for the clinical patient encounter and displaying the DRG in the GUI via the at least one display; and
in response to user input changing the set of user-approved medical billing codes by approving or removing approval of an engine-suggested medical billing code in the GUI, automatically updating the DRG based on the changed set of user-approved medical billing codes for the clinical patient encounter, and displaying the updated DRG in the GUI via the at least one display.
